(19) United States
(12) Patent Application Publication
(10) Pub. No.: US 2014/0158300 A1
(43) Pub. Date: Jun. 12, 2014

(54) PROTECTIVE SHEET FOR GLASS ETCHING

(71) Applicants: Maiko Hayata, Osaka (JP); Michirou Kawanishi, Osaka (JP); Yu-Han Yuan, Kaohsiung (TW); Jen-Chun Fang, Kaohsiung (TW)

(72) Inventors: Maiko Hayata, Osaka (JP); Michirou Kawanishi, Osaka (JP); Yu-Han Yuan, Kaohsiung (TW); Jen-Chun Fang, Kaohsiung (TW)

(73) Assignees: NITTO DENKO (TAIWAN) CORPORATION, Kaohsiung (TW); NITTO DENKO CORPORATION, Ibaraki-shi, Osaka (JP)

(21) Appl. No.: 14/233,633

(22) PCT Filed: Jun. 8, 2012
(86) PCT No.: PCT/JP2012/064837

§ 371 Date: Feb. 6, 2014

(30) Foreign Application Priority Data
Jul. 21, 2011 (JP) 2011-159781
Feb. 17, 2012 (JP) 2012-033241

(51) Int. Cl. C03B 19/00

(52) U.S. Cl. CPC C03B 19/00
USPC 156/345.3

(57) ABSTRACT

This invention provides a protective sheet for glass etching, having excellent etching solution penetration resistance, non-contaminating property and peeling efficiency. The protective sheet comprises a substrate and a PSA layer provided on one face of the substrate, such that, when the protective sheet is adhered to a non-etching area when etching glass, it protects the non-etching area from an etching solution. The PSA layer is constituted with a PSA having a gel fraction of 60% or higher. The PSA is an acrylic PSA comprising an acrylic polymer as a primary component. The acrylic polymer is synthesized by polymerizing starting monomers comprising, as a primary monomer, a monomer represented by a formula: CH₂═CR¹COOR² (R¹ is a hydrogen atom or a methyl group, and R² is an alkyl group). The primary monomer comprises as a primary component a monomer with R² being an alkyl group having 6 or more carbons.

### TECHNICAL FIELD

The present invention is related to a protective sheet for glass etching, particularly to a protective sheet for glass etching used when subjecting a glass surface to an erosional treatment (etching treatment) with an etching solution such as a hydrofluoric acid solution, etc., so as to mask an area where effects by the etching solution should be avoided. More specifically, it is related to a protective sheet for glass etching to mask a glass surface when subjecting sides of the glass to an etching treatment with an etching solution such as a hydrofluoric acid solution, etc. The present invention claims priority based on Japanese Patent Application Nos. 2011-159781 filed on Jul. 21, 2011 and 2012-33241 filed on Feb. 17, 2012, and the entire contents thereof are incorporated herein by reference.

### BACKGROUND ART

In glass processing, a polishing process is carried out to remove burrs formed on cut-edge surfaces of cut glass or to make glass thinner. In polishing processes, however, there have been problems such as glass surfaces getting scratched or cracking, resulting in reduced glass strength. Accordingly, instead of a polishing process, cut-edge surfaces or surfaces of glass are dissolved with an etching solution such as a hydrofluoric acid solution, etc., to remove burrs or microcracks on the cut-edge surfaces, thereby preventing a reduction in the glass strength. Etching solutions are used to adjust glass thickness as well.

Lately, in tablet computers, mobile phones and organic LED (light-emitting diode), transparent conductive film (e.g. ITO (indium tin oxide) film) or an FPC (flexible printed circuit) formed partially on a glass substrate has been widely used. Among these, tablet computers and mobile phones using touch-screen displays have gained significant popularity. When subjecting such a glass substrate having ITO film, etc., formed thereon to a surface treatment with an etching solution, the area on which the ITO film is formed needs to be protected from exposure to the etching solution. Thus, there have been experiments to protect non-etching areas of ITO film, etc., from etching solutions, such as by using, as a glass surface-protective sheet, a pressure-sensitive adhesive (PSA) sheet comprising PSA applied on a resin substrate such as a vinyl chloride substrate, etc., and applying such a protective sheet doubly onto ITO film or an FPC. However, it has not been able to surely stop an etching solution from swelling and penetrating the thickness direction of a glass substrate or from penetrating interfaces between PSA and a glass substrate around the periphery of the glass surface protective sheet, giving rise to problems such as an etching solution penetrating a non-etching area to damage ITO film or an FPC, or an area not to be etched getting eroded, etc. When highly adhesive PSA is used to stop an etching solution from penetrating interfaces between the PSA and a glass substrate, problems have been encountered, such that upon removal of the glass surface protective sheet after an etching treatment, the glass surface protective sheet itself ruptures, the glass as the adherend becomes contaminated with the PSA (so-called adhesive transfer), or the heavy release damages ITO film, etc., on the glass substrate surface.

Conventional art dealing with these problems include Patent Document 1. In Patent Document 1, a removable PSA sheet having a PSA layer formed from a radiation-curable PSA is used as a protective sheet, with it being designed so that this PSA sheet is adhered over its PSA layer side to an adherend to protect the adhered (masked) area during an etching treatment, and the PSA sheet is then irradiated prior to its removal to harden the PSA and reduce the peel strength.

Patent Document 2 is cited for a conventional glass surface protective sheet that prevents a flat glass surface from collecting dirt or getting scratched. Techniques to protect ITO film formed on glass substrate surfaces with resist masks are disclosed in Patent Documents 3 and 4. Patent Document 3 discloses a means comprising: forming protective layers consisting of resist mask on the front and back faces of non-cutting area of a glass substrate, subsequently cutting the glass substrate by subjecting the area without resist mask to an etching treatment combined with a cutting means such as breaking methods and the like, further polishing and etching cut-edge surfaces of the glass substrate, and then removing the resist mask. The art of Patent Document 4 is related to Patent Document 3, disclosing a means comprising: adhering a polypropylene sheet to the back face of a glass substrate to cover the entire surface and cutting the glass substrate apart by an etching treatment to form multiple glass substrate pieces on the polypropylene sheet with each piece having dimensions as a single item.

### CITATION LIST

### Patent Literature

[Patent Document 1] Japanese Patent Application Publication No. 2010-53346
[Patent Document 2] Japanese Patent Application Publication No. 2003-82299
[Patent Document 3] Japanese Patent Application Publication No. 2011-164508
[Patent Document 4] Japanese Patent Application Publication No. 2011-170063

### SUMMARY OF INVENTION

### Technical Problem

In short, a PSA sheet for glass etching (or “a protective sheet for glass etching” or further abbreviated to “a protective sheet” hereinafter) that masks and protects a non-etching area of glass while etching the glass (typically a glass substrate, or glass substrate plate) is expected to have properties including resistance (sealing ability) against penetration of etching solutions such as an ability to prevent etching solutions from swelling and penetrating surfaces and an ability to prevent etching solutions from penetrating at the periphery (or edges or sides hereinafter) of the protective sheet, etc.; an ability (surface structure conformability) to conform to a surface structure of a non-etching area having an uneven surface with ITO film or the like formed thereon, etc.; an ability (adhesiveness) to realize tight adhesion without floating or peeling, a feature (non-contaminating property) to cause no adhesive transfer to a surface of an adherend (typically a glass substrate) during its removal; and so on. It is also expected to have excellent workability for application and removal of the protective sheet. The workability for application (application efficiency) can be, for example, an ability to allow easy application without wrinkling, floating or twisting for applying the protective sheet to an adherend. The workability for removal (peeling efficiency) includes, for instance, an ability (anti-tearing property) to resist tearing of the protective sheet itself during removal of the protective sheet, a property not to cause damage to adherends during removal (e.g. an ability to prevent a glass adherend from cracking, a feature not to cause damage to ITO film, etc., on an adherend surface; or adherend-non-invasive properties), and light releasability. For example, when good application efficiency cannot be obtained, the protective sheet may form a void at an interface with the adherend and an etching solution may happen to penetrate into the void; and therefore, the etching solution penetration resistance (sealing ability) can be greatly affected as well.

In particular, when focused on the etching solution penetration resistance, non-contaminating property and light releasability, the art of Patent Document 1 related to a removable PSA sheet using a radiation-curable PSA is preferable. When a radiation-curable PSA is used, however, a necessary irradiation step adds to the number of steps while it also necessitates an environment where the PSA is not exposed to radiation during the steps, requiring equipment for this purpose.

When focused on the adhesiveness including the surface structure conformability, sealing ability and light releasability, for example, if a thin substrate or a highly flexible substrate is used to increase the adhesiveness, the flexural property (rigidity) of the protective sheet decreases, and wrinkling, floating or twisting may occur while adhering the protective sheet to an adherend, giving rise to a possibility of etching solution penetration. When removing the protective sheet from an adherend (a glass substrate or ITO film formed on a glass substrate, etc.), it is concerned that heavy release may lead to reduced workability, such as ITO film, etc., undesirably peeling off the glass substrate, or splitting or tearing of the protective sheet itself, etc. Accordingly, it is not easy to meet the properties described above at a high level. Regarding these aspects, the art according to Patent Document 2 is intended for an adherend having a smooth surface, thus, surface structure conformability cannot be expected for a glass substrate having an uneven structure on its adhering surface. Patent Document 3 teaches to use a removable protective sheet in place of resist mask to protect a glass substrate surface having ITO film, etc., formed thereon. Patent Document 4 teaches to protect ITO film, etc. with a slightly-adhesive polypropylene sheet having a resist layer formed of acrylic resin, etc. However, they do not describe any specific ways as to how these protective sheets are allowed to conform to a surface structure where ITO film, etc., is formed, or about how to realize adhesiveness, sealing ability and light releasability. Patent Document 1 does not disclose specific ways, either, regarding a constitution of a protective sheet substrate to realize the surface structure conformability described above or a constitution of the substrate to bring about the adhesiveness, sealing ability and light releasability described above.

The present invention has been made to solve these problems. An objective of its first embodiment is to provide a protective sheet for glass etching such that when treating a surface of glass (typically a glass substrate) with an etching solution such as a hydrofluoric acid solution, etc., it does not allow penetration of the etching solution into a masked area (an area to which the protective sheet for glass etching is adhered); and upon its removal, it does not contaminate the surface of the adherend (a glass substrate or ITO film, etc.) with its PSA, or damage the protective sheet itself or the adherend by heavy release; that is, a protective sheet for glass etching exhibiting excellent etching solution penetration resistance, non-contaminating properties and peeling efficiency (anti-tearing property and adherend-non-invasive property).

An objective of the second embodiment of the present invention is to provide a protective sheet for glass etching, having excellent conformability to an adherend's surface structure which leads to increased adhesiveness which in turn leads to further increased sealing ability.

### Solution to Problem

The first embodiment of the present invention provides a protective sheet for glass etching comprising a substrate and a PSA layer provided on one face of the substrate, such that, when the protective sheet is adhered to a non-etching area when etching glass, it protects the non-etching area from an etching solution. In the protective sheet for glass etching, the PSA constituting the PSA layer has a gel fraction of 60% or higher and the PSA is an acrylic PSA comprising an acrylic polymer as a primary component, with the acrylic polymer being synthesized by polymerizing starting monomers comprising as a primary monomer a monomer represented by a formula:

CH₂═CR¹COOR²

(in the formula, R¹ is a hydrogen atom or a methyl group, and R² is an alkyl group) with the primary monomer being characterized by comprising, as a primary component, a monomer with R² in the formula being an alkyl group having 6 or more carbons.

According to a protective sheet having such a constitution, since the gel fraction of PSA is 60% or higher, sufficient cohesive strength can be obtained. Thus, when removing the protective sheet, it does not cause contamination such as adhesive transfer, etc., and it releases lightly as well. With the good adhesive strength obtained, it can prevent penetration of etching solutions from sides of the protective sheet. Furthermore, the primary monomer used for synthesis of the acrylic polymer contained in the PSA comprises as a primary component a monomer with R² in the formula being an alkyl group having 6 or more carbons. Thus, the increased number of carbons in R² increases the hydrophobicity, allowing prevention of etching solution penetration.

In such a protective sheet for glass etching, the protective sheet for glass etching comprises a substrate and a PSA layer provided on one face of the substrate, such that, when the protective sheet is adhered to a non-etching area when etching glass, it protects the non-etching area from an etching solution, wherein the PSA layer preferably has a gel fraction of 60% or higher, with the PSA layer being preferably an acrylic polymer formed with a primary monomer being a monomer represented by the formula (1):

CH₂═CR¹COOR² (1)

(in the formula, R¹ is a hydrogen atom or a methyl group, and R² is an alkyl group having 6 or more carbons).

In such a protective sheet for glass etching, the PSA layer preferably comprises a monomer having a carboxyl group or a hydroxyl group.

In such a protective sheet for glass etching, the substrate preferably has a thickness of 80 μm or larger.

It preferably has an adhesive strength to glass of 0.05 N/20 mm to 3.00 N/20 mm.

In such a protective sheet for glass etching, the substrate preferably comprises a layer formed from polypropylene (PP), polyethylene (PE), polyethylene terephthalate (PET), polyvinyl chloride (PVC), polyimide (PI), polybutylene terephthalate (PBT), polyphenylene sulfide (PPS), ethylene vinyl acetate (EVA) or polytetrafluoroethylene (PTFE).

In such a protective sheet for glass etching, it is preferable that the PSA comprises a crosslinking agent, and the crosslinking agent is an epoxy-based crosslinking agent or an isocyanate-based crosslinking agent.

It is preferably used as a surface protective sheet for a glass substrate, such that, when, before etching surfaces of the glass substrate, the protective sheet for glass etching is adhered over its PSA layer side to a non-etching area of one surface of the glass substrate, it protects the non-etching area from an etching solution. Preferable examples of such an application include an application where one surface of a glass substrate is treated with an etching solution to adjust the thickness of the glass substrate (typically to make it thinner).

The second embodiment of the present invention provides a protective sheet for glass etching, comprising a substrate and a PSA layer provided at least on one surface of the substrate. It is characterized by the protective sheet for glass etching having a strength T_{M25} at 10% stretch in its MD (machine direction) at a temperature of 25° C. and a strength T_{T25} at 10% stretch in its TD (transverse direction) perpendicular to the MD at the same temperature, of which at least one value is 1 N/cm to 25 N/cm.

Since such a protective sheet has an MD or TD strength of 1 N/cm or greater at 10% stretch, the protective sheet has suitable hardness. Thus, when adhering it to an adherend, it is unlikely to wrinkle, float or twist, making it easy to apply. With the strength at 10% stretch being 25 N/cm or less, the protective sheet is not excessively hard. Thus, even on glass having an uneven surface, it is able to sufficiently conform to the surface structure of the glass and provides excellent adhesion. Accordingly, at sides of the protective sheet, there will be no formation of a void such as wrinkles or the like through which an etching solution could penetrate, whereby the sealing ability increases.

It is preferable that the protective sheet has a flexural rigidity D_{M25} in the MD at a temperature of 25° C. and a flexural rigidity D_{T25} in the TD at the same temperature, of which at least one value is 1.5×10⁻⁵ Pa·m³ to 10×10⁻⁵ Pa·m³. This allows the protective sheet to have suitable rigidity (flexural strength). Thus, when placing the protective sheet at a prescribed location of an adherend, it is unlikely to wrinkle, float or twist, providing excellent workability. When removing the protective sheet from glass, an elastic force (a force to work against flexural deformation to restore its original shape) of the protective sheet can be utilized as part of peel strength. In view of this aspect also, it is highly workable. A protective sheet having such a constitution can combine high levels of sealing ability and workability.

In such a protective sheet for glass etching, it is preferable that a release liner to be placed on a surface opposite of the substrate side of the PSA layer has an arithmetic mean surface roughness of 0.05 μm to 0.75 μm. This allows the protective sheet to maintain the PSA surface (adhering face) highly smooth until it is used. Accordingly, the PSA (layer) surface (adhering face) on which the release liner is placed will be highly smooth, allowing the stress arising due to its removal from a glass surface to be distributed more evenly. Thus, it allows avoidance of an event of the PSA being partially torn off by some local stress concentration and partially left on the adherend side, etc. When it becomes less smooth, the PSA layer may form a void due to floating, etc., at interfaces with an adherend, and an etching solution may penetrate the protective sheet through the void. However, with use of a release liner having an arithmetic mean surface roughness as described above, such a problem can be avoided.

Such a protective sheet for glass etching is preferably used as a protective sheet for both surfaces of a glass substrate, such that, when, before etching a side being a cut-edge surface of the glass substrate, at least two sheets of the protective sheet for glass etching are adhered over their respective PSA layer sides to both the surfaces of the glass substrate, they protect the both surfaces of the glass substrate from an etching solution. Preferable examples of such an application include an application where a side being a cut-edge surface of a glass substrate is treated with an etching solution to remove burrs and microcracks on the cut-edge surface so as to increase the glass strength.

### BRIEF DESCRIPTION OF DRAWINGS

FIG. 1 shows a cross-sectional view schematically illustrating a constitution example of the protective sheet for glass etching.

FIG. 2 shows a cross-sectional view schematically illustrating another constitution example of the protective sheet for glass etching.

FIG. 3 is a side view schematically illustrating a method for evaluation of deflection angles.

FIG. 4 shows a top view schematically illustrating a usage example of the protective sheet for glass etching according to the second embodiment.

FIG. 5 shows a schematic cross-sectional view taken along line V-V in FIG. 4.

FIG. 6 shows a schematic cross-sectional view corresponding to FIG. 5, illustrating another usage example of the second embodiment.

FIG. 7 shows a graph illustrating the results of penetration tests of an etching solution in Reference Examples 1 to 3.

### DESCRIPTION OF EMBODIMENTS

Preferred embodiments of the present invention are described below. Technical matters necessary to practice the invention, other than those specifically referred to in the present description, may be understood as design matters for a person skilled in the art that are based on the related art in the pertinent field. The present invention may be practiced based on the contents disclosed herein and common general technical knowledge in the pertinent field. The concept of the “sheet” in this description encompasses film which is perceived to be thinner than a sheet as well as tape such as what is generally referred to as PSA tape.

The protective sheet for glass etching according to the first embodiment (which may be abbreviated to the protective sheet hereinafter) is described below.

The protective sheet for glass etching according to the present invention is characterized by that it comprises a substrate and a PSA layer provided on one face of the substrate, that when it is adhered to a non-etching area when etching glass, it protects the non-etching area from an etching solution, and the PSA layer having a gel fraction of 60% or higher with the PSA layer being an acrylic polymer formed with a primary monomer being a monomer represented by a formula (1):

CH₂═CR¹COOR² (1)

(in the formula, the formula, R¹ is a hydrogen atom or a methyl group, and R² is an alkyl group having 6 or more carbons).

The PSA has a gel fraction of preferably 60% or higher, more preferably 70% or higher, or even more preferably 75% or higher. A low gel fraction leads to contamination such as adhesive transfer, etc., when the protective sheet is removed. With a higher gel fraction, liquid penetration through a side of the protective sheet can be prevented.

The primary monomer of the polymer of the PSA according to the present application is a monomer represented by the formula (1) wherein R² is an alkyl group having 6 or more carbons. With increasing number of carbons in R², the hydrophobicity increases and effects to prevent etching solution penetration can be expected.

The PSA layer in such a protective sheet for glass etching can comprise a functional group-containing monomer possibly containing a carboxyl group, a hydroxyl group, a glycidyl group, etc. In particular, a carboxyl group is preferable as the functional group.

The substrate is preferably formed of polypropylene (PP), polyethylene (PE), polyethylene terephthalate (PET), polyvinyl chloride (PVC), polyimide (PI), polybutylene terephthalate (PBT), polyphenylene sulfide (PPS), ethylene vinyl acetate (EVA), polytetrafluoroethylene (PTFE), etc., or more preferably formed of PP, PE or PET, or in view of the balance between the flexibility and acid resistance, PE and PP are more preferable. In PP, PE may be blended. When flexible film is used, upon adhesion to a glass surface having ITO film or an FPC adhered thereon, it is able to conform to the unevenness, making it less likely to form channels for penetration of an etching solution such as a hydrofluoric acid solution, etc.

From the standpoint of the handling properties and preventing etching solutions from penetrating the sheet surface, the substrate has a thickness of preferably 80 μm or larger, or more preferably 100 μm or larger. To enhance anchoring of the PSA, it is preferable that a surface to which the PSA is to be applied is subjected to a corona treatment or a primer treatment using an undercoating agent containing an acrylic polymer and an isocyanate, etc. To reduce the unwinding force required for unwinding the protective sheet, the opposite face not in contact with the PSA may be provided with a release layer of long-chain alkyl-based or silicone-based layer.

The protective sheet for glass etching of the present application has an adhesive strength to glass of preferably 3 N/20 mm or less or more preferably 2 N/20 mm or less. To avoid peeling during an etching treatment to glass, the protective sheet of the present application has an adhesive strength to glass of preferably 0.05 N/20 mm or greater. With the adhesive strength being excessively high, when removing the protective sheet after an etching treatment, the glass as the adherend may break.

As the crosslinking agent, can be used isocyanate-based crosslinking agents, epoxy-based crosslinking agents, melamine-based crosslinking agents, etc. From the standpoint of the handling properties such as the storability, etc., as well as the acid resistance, preferable is a crosslink of carboxyl group and an epoxy-based crosslinking agent or an isocyanate-based crosslinking agent. The amount of crosslinking agent added is preferably 0.5 part by mass to 10 parts by mass relative to 100 parts by mass of the acrylic polymer, or more preferably 1 part by mass to 7 parts by mass. It is preferable to add a crosslinking agent in an amount within this range in view of combining light releasability and adhesiveness.

The polymer comprises a side chain derived from one or more monomer species represented by the formula (1):

CH₂═CR¹COOR² (1)

(in the formula, R¹ is a hydrogen atom or a methyl group, and R² is an alkyl group having 6 or more carbons), that is, a (meth)acrylic acid ester.

Here, an alkyl group of the (meth)acrylic acid ester has 6 or more of carbon atoms. In view of the availability of starting materials, production ease, effects of suppressing chemical solution penetration and so on, it is suitable that the number of carbons is about 30 or smaller. Specific examples include hexyl, heptyl, octyl, nonyl, ethylhexyl, propylhexyl, and the like.

It is suitable that this alkyl (meth)acrylate is polymerized as a monomer at a ratio of 50 mol % or greater of all the monomers constituting the polymer main chain. This is to make it effective in sufficiently suppressing penetration of a chemical solution or the like into the PSA when the polymer is used as removable PSA in an embodiment as described later,

As the polymer, while any polymer capable of providing adhesiveness can be used, in view simple molecular designing and so on, an acrylic polymer is preferable.

Examples of the acrylic polymer include acrylic polymers comprising, as monomer(s), one, two or more species of (meth)acrylic acid alkyl esters (e.g. linear or branched alkyl esters having 1 to 30 carbons, especially those having 4 to 18 carbons, such as methyl ester, ethyl ester, propyl ester, isopropyl ester, butyl ester, isobutyl ester, s-butyl ester, t-butyl ester, pentyl ester, isopentyl ester, hexyl ester, heptyl ester, octyl ester, 2-ethylhexyl ester, isooctyl ester, nonyl ester, isononyl ester, decyl ester, isodecyl ester, undecyl ester, dodecyl ester, tridecyl ester, tetradecyl ester, hexadecyl ester, octadecyl ester, eicosyl ester, etc.) and (meth)acrylic acid cycloalkyl esters (e.g. cyclopentyl ester, cyclohexyl ester, etc.).

To modify the cohesive strength, heat resistance, etc., as necessary, the polymer may comprise as a comonomeric unit a different monomer (or an oligomer) copolymerizable with the (meth)acrylic acid alkyl ester or cycloalkyl ester.

Examples of such a monomer (or an oligomer) include carboxyl group-containing monomers such as acrylic acid, methacrylic acid, carboxyethyl (meth)acrylate, carboxypentyl (meth)acrylate, itaconic acid, maleic acid, fumaric acid, crotonic acid, etc.; acid anhydride group-containing monomers such as maleic anhydride, itaconic anhydride, etc.; hydroxyl group-containing monomers such as 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, (4-hydroxymethylcyclohexyl)methyl (meth)acrylate, N-methylol(meth)acrylamide, vinyl alcohol, allyl alcohol, 2-hydroxyethyl vinyl ether, 4-hydroxybutyl vinyl ether, diethylene glycol mono-vinyl ether, etc.; sulfonate group-containing monomers such as styrene sulfonate, allylsulfonate, 2-(meth)acrylamide-2-methylpropane sulfonate, (meth)acrylamidepropane sulfonate, sulfopropyl (meth)acrylate, (meth)acryloyloxynaphthalene sulfonate, etc.; phosphate group-containing monomers such as 2-hydroxyethylacryloylphosphate, etc.; epoxy group-containing monomers such as glycidyl (meth)acrylate, acryl glycidyl ether, etc.; vinyl esters such as vinyl acetate, etc.; aromatic vinyl compounds such as styrene, etc.; vinyl ethers such as vinyl ethyl ether, etc.; and the like.

The monomer (or the oligomer) includes nitrogen atom-containing monomers, for example, cyano group-containing monomers such as acrylonitrile, etc.; amide group-containing monomers such as acrylamide, etc.; amino group-containing monomers such as N,N-dimethylaminoethyl (meth)acrylate, etc.; isocyanate group-containing monomers described later; and the like. Among these monomers, one, two or more species can be used.

The amount of the other copolymerizable monomer (or oligomer) is suitably at 0.1 mol % or greater of all the monomers constituting the polymer main chain, or preferably around 0.1 mol % to 30 mol %.

For a crosslinking treatment, etc., the polymer may comprise a polyfunctional monomer, etc., as a comonomeric unit as necessary.

Examples of such a monomer include hexanediol di(meth)acrylate, (poly)ethylene glycol di(meth)acrylate, (poly)propylene glycol di(meth)acrylate, neopentyl glycol di(meth)acrylate, pentaerythritol di(meth)acrylate, trimethylolpropane tri(meth)acrylate, pentaerythritol tri(meth)acrylate, dipentaerythritol hexa(meth)acrylate, epoxy(meth)acrylate, polyester(meth)acrylate, urethane(meth)acrylate, etc. Among these polyfunctional monomers, one, two or more species can be used as well.

In view of the adhesive properties, etc., the amount of the polyfunctional monomer is preferably at 30 mol % or less of all the monomers constituting the polymer main chain.

The polymer can be obtained by polymerizing a monomer mixture comprising a single monomer, or two or more species. The polymerization can be carried out by any method among solution polymerization, emulsion polymerization, bulk polymerization, suspension polymerization, and so on.

The state of the PSA composition is not particularly limited. It can be in various states such as solvent-based, emulsion-based, aqueous solution-based, active energy ray (ultraviolet ray (UV))-curing type, hot-melt type, etc. Typically, it is prepared by dissolving or dispersing the acrylic polymer along with other components (crosslinking agent, crosslinking accelerator, etc.) in a suitable solvent. For example, it can be a solvent-based PSA composition obtainable by dissolving an acrylic polymer obtained via emulsion polymerization followed by procedures such as pH adjustment, salting-out, purification and so forth, along with a crosslinking agent, crosslinking accelerator and various additives (optional ingredients) as necessary in an organic solvent such as toluene, ethyl acetate, etc.

The removable PSA (the PSA constituting the PSA layer) of the present invention may further comprise additives such as crosslinking agent, etc.

Examples of the crosslinking agent include crosslinking agents known in the pertaining field, such as cyanate-based crosslinking agents, oxazoline-based crosslinking agents, metal chelate-based crosslinking agents, epoxy-based crosslinking agents, aziridine-based crosslinking agents, isocyanate-based crosslinking agents such as polyisocyanate, etc.; and the like.

The removable PSA sheet (the protective sheet for glass etching) of the present invention comprises a PSA layer formed from a removable PSA described above on a substrate film.

This PSA sheet can be fabricated by applying a PSA composition comprising a removable PSA onto a substrate film and allowing it to dry.

It can be fabricated also by applying onto a suitable separator (release paper, etc.) a PSA composition comprising a removable PSA, allowing it to dry to form a PSA layer, and transferring (transporting and sticking) this onto a substrate film.

The substrate film is not particularly limited, and a known species can be used.

Examples of the substrate film include plastic films including polyester film such as polyethylene terephthalate (PET) film, polybutylene terephthalate (PBT) film, polyethylene naphthalate film, etc.; polyolefinic film such as biaxially oriented polypropylene (OPP) film, low-density polyethylene (PE) film, various kinds of soft polyolefin film, etc.; ethylene-vinyl acetate copolymer (EVA) film; and the like as well as multi-layer films comprising these films, etc.

The substrate film has a thickness of, for instance, about 80 μm to 300 μm.

The thickness of the PSA layer can be suitably adjusted. In general, it is 1 μm to 100 μm, preferably 2 μm to 40 μm, or more preferably about 3 μm to 30 μm.

The shape of the PSA sheet is not particularly limited and can be suitably selected according to the intended use.

The removable PSA sheet (the protective sheet for glass etching) of the present invention can be used as a PSA sheet to be adhered to a desirable area of a glass substrate to protect the area. In other words, the PSA used in this PSA sheet is unlikely to undergo alteration, dissolution or the like by a chemical solution, etc., even when the glass substrate is exposed to a liquid, especially an acidic or basic chemical solution during etching, washing and so on. On an area not to be exposed to a chemical solution, etc., it is able to surely prevent penetration of a chemical solution, etc., and protect the surface.

The protective sheet according to the first embodiment is described more in detail or from different aspects. Such description can be referred to as necessary to comprehend the protective sheet according to the first embodiment described above.

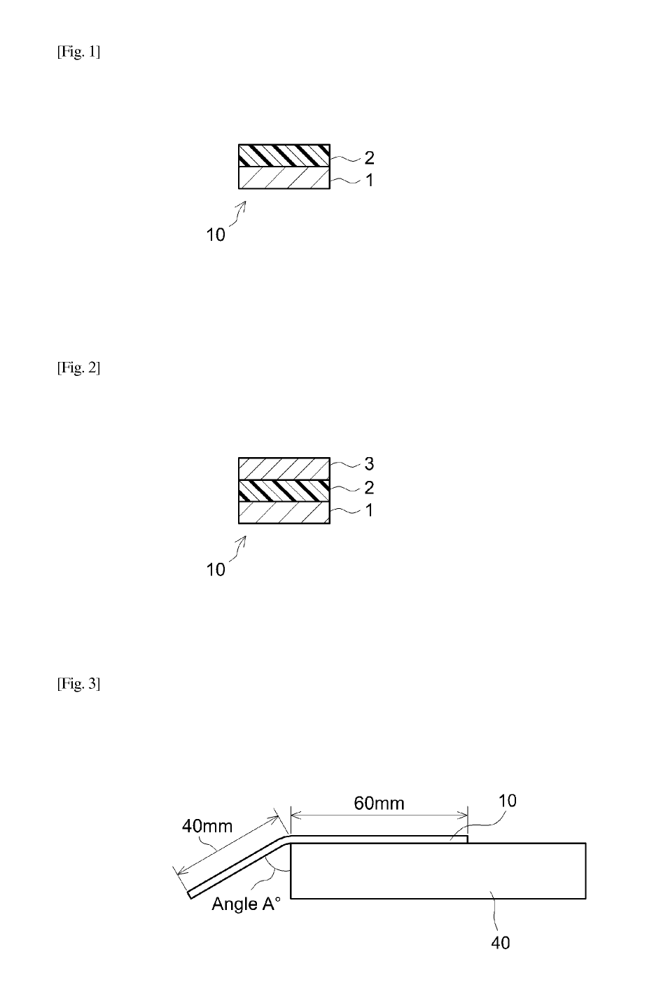

The protective sheet disclosed herein comprises a substrate and a PSA layer provided on one face of the substrate. A typical constitution example of such a protective sheet is schematically illustrated in FIG. 1. This protective sheet 10 comprises a resin substrate sheet 1 and a PSA layer 2 provided on a first face (one face) thereof. When used, this protective sheet 10 is adhered over the PSA layer 2 side to a prescribed area (an area to be protected, typically an area where effects by an etching solution should be avoided (or a “non-etching area” hereinafter)) of an adherend before the adherend (typically a glass substrate) is etched. This allows protection of the non-etching area from an etching solution. Typically, as shown in FIG. 2, prior to use (i.e. before adhered to the adherend), protective sheet 10 may typically be present in such a state where the surface (adhering face) of the PSA layer 2 is protected with a release liner 3 having a release face at least on the PSA layer 2 side. Alternatively, it may be present in such a state where, with substrate 1 having a release face on the other face (the back face of the surface on which PSA layer 2 is provided), protective sheet 10 is wound in a roll so that the other face contacts the PSA layer 2 and protects the surface. As long as the protective sheet is in a sheet form, it may be present as a roll or as a single plate with a separator, etc.

In particular, the PSA constituting the PSA layer is an acrylic PSA comprising an acrylic polymer as a base polymer (a primary component among the polymers, primary adhesive ingredient). The term “acrylic polymer” typically refers to a polymer (copolymer) obtained by polymerizing starting monomers (a single monomer species or a monomer mixture) that comprise an alkyl (meth)acrylate as a primary monomer and may further comprise an optional monomer copolymerizable with the primary monomer. The term “(meth)acrylate” refers collectively to acrylate and methacrylate. Likewise, the term “(meth)acryloyl” refers collectively to acryloyl and methacryloyl, and the term “(meth)acryl” refers collectively to acryl and methacryl.

Similarly, the PSA composition used to form a PSA (layer) comprises an acrylic polymer as a base polymer (a primary component among polymers, a primary adhesive ingredient).

The starting monomers used in polymerization to obtain the acrylic polymer comprises, as a primary monomer, a monomer represented by the formula:

CH₂═CR¹COOR²

(In the formula, R¹ is a hydrogen atom or a methyl group while R² is an alkyl group). The alkyl group is either linear or branched. The primary monomer comprises, as a primary component, a monomer (primary monomer A) with R² in the formula being an alkyl group having 6 or more carbons. The alkyl group (R²) of the primary monomer A has preferably 7 or more (typically 8) carbons. With increasing number of carbons in such an alkyl group, the hydrophobicity increases and effects of preventing etching solution penetration can be expected. In view of the availability of starting materials, production ease and etching solution penetration resistance, the number of carbons is preferably about 30 or smaller. In particular, an alkyl (meth)acrylate with R² being a hexyl group, heptyl group, octyl group, nonyl group, 2-ethylhexyl group, or propylhexyl group is preferable. An alkyl (meth)acrylate with R² being a 2-ethylhexyl group is more preferable. Among these monomers, solely one species or a combination of two or more species can be used.

To adjust the glass transition temperature (Tg) or to increase the cohesive strength, the primary monomer may further comprise a monomer other than the monomer (primary monomer A) with R² in the formula being an alkyl group with 6 or more carbons, that is, an alkyl (meth)acrylate (primary monomer B) having an alkyl group with 1 to 5 carbons. Examples of such alkyl (meth)acrylates include alkyl (meth)acrylates such as methyl (meth)acrylate, ethyl (meth)acrylate, propyl (meth)acrylate, isopropyl (meth)acrylate, butyl (meth)acrylate, isobutyl (meth)acrylate, s-butyl (meth)acrylate, t-butyl (meth)acrylate, pentyl (meth)acrylate, isopentyl (meth)acrylate, and the like. Among these, can be used one species solely or a combination of two or more species.

The ratio of the monomer (primary monomer A) with R² in the formula being an alkyl group having 6 or more carbons is above 50% by mass. From the standpoint of increasing the hydrophobicity of the resulting PSA and increasing the etching solution penetration resistance, it is preferably 80% by mass or higher (e.g. 90% by mass or higher, typically 95% by mass or higher). It is more preferable to use, as the primary monomer, solely a monomer (primary monomer A) with R² in the formula being an alkyl group having 6 or more carbons. Thus, it is preferable that the ratio of an alkyl (meth)acrylate (primary monomer B) having an alkyl group with 1 to 5 carbons in the primary monomer is 10% by mass or lower (typically 5% by mass or lower), and it is more preferable that such an alkyl (meth)acrylate (primary monomer B) is not used.

To increase various features such as the non-contaminating property, light releasability, heat resistance, etc., the starting monomers used in polymerization to produce the acrylic polymer may comprise, in addition to the primary monomer, an optional monomer that is copolymerizable with the primary monomer as a comonomeric unit. The optional monomer encompasses not only monomers, but also oligomers.

The optional monomer can be a monomer having a functional group (or a functional group-containing monomer, hereinafter). Such a functional group-containing monomer can be added to incorporate crosslinking points into the acrylic polymer and increase the cohesive strength of the acrylic polymer. Examples of such a functional group-containing monomer include:

carboxyl group-containing monomers including ethylenic unsaturated mono-carboxylic acids such as acrylic acid, methacrylic acid, crotonic acid, carboxyethyl (meth)acrylate, carboxypentyl (meth)acrylate, etc.; ethylenic unsaturated dicarboxylic acids such as itaconic acid, maleic acid, fumaric acid, citraconic acid, etc.; and the like;

acid anhydride group-containing monomers such as acid anhydrides of the ethylenic unsaturated dicarboxylic acids, such as maleic anhydride, itaconic anhydride, etc.;

hydroxyl group-containing monomers including hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, (4-(hydroxymethylcyclohexyl)methyl (meth)acrylate, etc.; unsaturated alcohols such as N-methylol(meth)acrylamide, vinyl alcohol, allyl alcohol, 2-hydroxyethyl vinyl ether, 4-hydroxybutyl vinyl ether, diethylene glycol monovinyl ether, etc.; and the like;

functional group-containing monomers having nitrogen atoms in the functional groups, with examples including the following amide group-containing monomers, amino group-containing monomers and cyano group-containing monomers, etc., such as:

amide group-containing monomers such as (meth)acrylamide, N,N-dimethyl(meth)acrylamide, N-butyl(meth)acrylamide, N-methylol(meth)acrylamide, N-methylolpropane(meth)acrylamide, N-methoxymethyl(meth)acrylamide, N-butoxymethyl(meth)acrylamide, etc.;

amino group-containing monomers such as aminoethyl (meth)acrylate, N,N-dimethylaminoethyl (meth)acrylate, t-butylaminoethyl (meth)acrylate, etc.;

cyano group-containing monomers such as acrylonitrile, methacrylonitrile, etc.;

sulfonate group-containing monomers such as styrene sulfonate, allyl sulfonate, 2-(meth)acrylamide-2-methylpropane sulfonate, (meth)acrylamidepropane sulfonate, sulfopropyl (meth)acrylate, (meth)acryloyloxynaphthalene sulfonate, etc.;

phosphate group-containing monomers such as 2-hydroxyethylacryloyl phosphate, etc.;

epoxy group (glycidyl group)-containing monomers such as glycidyl (meth)acrylate, methylglycidyl (meth)acrylate, allyl glycidyl ether, etc.;

keto group-containing monomers such as diacetone(meth)acrylamide, diacetone(meth)acrylate, vinyl methyl ketone, vinyl ethyl ketone, allyl acetoacetate, vinyl acetoacetate, etc.;

isocyanate group-containing monomers such as 2-(meth)acryloyloxyethyl isocyanate, etc.;

alkoxy group-containing monomers such as methoxyethyl (meth)acrylate, ethoxyethyl (meth)acrylate, etc.; and

alkoxysilyl group-containing monomers such as (3-(meth)acryloxypropyl)trimethoxysilane, (3-(meth)acryloxypropyl)triethoxysilane, (3-(meth)acryloxypropyl)methyldimethoxysilane, (3-(meth)acryloxypropyl)methyldiethoxysilane, etc. Among these, can be used one species solely or a combination of two or more species. In particular, for their abilities to preferably incorporate crosslinking points into an acrylic polymer and increase the cohesive strength of the acrylic polymer, functional group-containing monomers containing a carboxyl group, hydroxyl group, epoxy group, etc., are preferable. Carboxyl group-containing monomers and hydroxyl group-containing monomers are more preferable.

The optional monomer may comprise a monomer other than the functional group-containing monomer to increase the cohesive strength of the acrylic polymer, etc. Examples of such monomers include:

vinyl ester-based monomers such as vinyl acetate, vinyl propionate, etc.;

aromatic vinyl compounds such as styrene, substituted styrenes (α-methylstyrene, etc.), vinyl toluene, etc.;

aromatic ring-containing (meth)acrylates such as aryl (meth)acrylate (e.g. phenyl (meth)acrylate), aryloxyalkyl (meth)acrylate (e.g. phenoxyethyl (meth)acrylate), arylalkyl (meth)acrylate (e.g. benzyl (meth)acrylate), etc.;

monomers having nitrogen atom-containing rings such as N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-vinylmorpholine, N-vinylcaprolactam, N-(meth)acryloyl morpholine, etc.;

olefinic monomers such as ethylene, propylene, isoprene, butadiene, isobutylene, etc.;

chlorine-containing monomers such as vinyl chloride, vinylidene chloride, etc.;

vinyl ether-based monomers such as methyl vinyl ether, ethyl vinyl ether, etc.; and

cycloalkyl (meth)acrylates such as cyclopentyl (meth)acrylate, cyclohexyl (meth)acrylate, etc. Among these, can be used one species solely or a combination of two or more species. In particular, from the standpoint of increasing the cohesive strength of the resulting acrylic polymer, vinyl ester-based monomers are preferable. Among them, vinyl acetate is more preferable.

The optional monomer may comprise a comonomer such as polyfunctional monomers, etc., for crosslinking treatment, etc. Examples of such polyfunctional monomers include hexanediol di(meth)acrylate, (poly)ethylene glycol di(meth)acrylate, (poly)propylene glycol di(meth)acrylate, neopentyl glycol di(meth)acrylate, pentaerythritol di(meth)acrylate, trimethylolpropane tri(meth)acrylate, pentaerythritol tri(meth)acrylate, dipentaerythritol hexa(meth)acrylate, epoxy(meth)acrylate, polyester(meth)acrylate, urethane(meth)acrylate, etc., among which, solely one species or a combination of two or more species can be used.

In terms of the content, the primary monomer should rank the highest among all the monomers (primary monomer and optional monomer) constituting the acrylic polymer main chain. From the standpoint of combining adhesive strength with light releasability and obtaining good etching solution penetration resistance, the primary monomer content is preferably higher than 50% by mass of all the monomers, or more preferably 60% by mass or higher (e.g. 70% by mass or higher, but 99% by mass or lower, typically 80% by mass or higher, but 98% by mass or lower). The ratio of the optional monomer is preferably lower than 50% by mass of all the monomers (e.g. 1% by mass to 40% by mass, 2% by mass to 20% by mass). In particular, when using a functional group-containing monomer described above as a monomer constituting the acrylic polymer main chain, from the standpoint of combining etching solution penetration resistance and light releasability while increasing the non-contaminating property and the light releasability, 1 part by mass to 10 parts by mass (e.g. 2 parts by mass to 8 parts by mass, typically 3 parts by mass to 7 parts by mass) of the functional group-containing monomer (preferably a carboxyl group-containing monomer) is preferably contained to 100 parts by mass of the primary monomer (an alkyl (meth)acrylate with R² in the formula being an alkyl group having preferably 6 or more carbons, or more preferably 8 carbons). When using a monomer other than the functional group-containing monomer as a monomer constituting the acrylic polymer main chain, from the standpoint of obtaining good etching solution penetration resistance, non-contaminating property and light releasability, 1 part by mass to 100 parts by mass (e.g. 2 parts by mass to 90 parts by mass, typically 5 parts by mass to 85 parts by mass) of the monomer (preferably a vinyl ester-based monomer such as vinyl acetate, etc.) other than the functional group-containing monomer is preferably contained to 100 parts by mass of the primary monomer (an alkyl (meth)acrylate with R² in the formula being an alkyl group having preferably 6 or more carbons, or more preferably 8 carbons). When using a polyfunctional monomer described above as a monomer constituting the acrylic polymer main chain, from the standpoint of obtaining good adhesive properties (e.g. adhesive strength) and etching solution penetration resistance, it is preferable that 30 parts by mass or less (e.g. 20 parts by mass or less, typically 1 part by mass to 10 parts by mass) of the polyfunctional monomer is contained to 100 parts by mass of the primary monomer.

The method for polymerizing the monomers or their mixture is not particularly limited, and a conventionally known general polymerization method can be employed. Examples of such polymerization methods include solution polymerization, emulsion polymerization, bulk polymerization, and suspension polymerization. Among these, for the excellent water resistance and etching solution penetration resistance obtained, solution polymerization is preferable. The embodiment of the polymerization is not particularly limited, and it can be carried out by suitably selecting a conventionally known monomer supply method, polymerization conditions (temperature, time, pressure, etc.), and other components (polymerization initiator, surfactant, etc.) besides the monomers. For example, as the monomer supply method, the entire monomer mixture can be supplied to a reaction vessel at once (all-at-once supply) or gradually supplied dropwise (continuous supply), or it can be divided into portions with each portion being supplied at a prescribed interval (portionwise supply). The monomers or their mixture may be supplied in part or in full as a solution dissolved in a solvent or as a dispersion emulsified in water.

The polymerization initiator is not particularly limited with examples including azo-based initiators, peroxide-based initiators, substituted ethane-based initiators, redox-based initiators combining peroxides and reductants, and so on. Examples of azo-based initiators include 2,2′-azobis(2-amidinopropane)dihydrochloride, 2,2′-azobis[N-(2-carboxyethyl)-2-methylpropionamidine]hydrate, 2,2′-azobisisobutyronitrile (AIBN), 2,2′-azobis-2-methylbutylonitrile (AMBN), 2,2′-azobis(2-methylpropionamidine)disulfate, 2,2′-azobis[2-(5-methyl-2-imidazolin-2-yl)propane]dihydrochloride and 2,2′-azobis(N,N′-dimethyleneisobutylamidine)dihydrochloride. Examples of peroxide-based initiators include persulfate salts such as potassium persulfate, ammonium persulfate, etc.; benzoyl peroxide (BPO), t-butyl hydroperoxide and hydrogen peroxide. Examples of substituted ethane-based initiators include phenyl-substituted ethanes. Examples of redox-based initiators include combinations of persulfate salts and sodium hydrogen sulfite, and combinations of peroxides and sodium ascorbate. Among these, from the standpoint of the etching solution penetration resistance, azo-based initiators are preferable.

The amount of polymerization initiator used can be suitably selected according to the type of polymerization initiator and the monomer species (composition of the monomer mixture), etc., while it is usually selected from a range of, for example, about 0.005 part by mass to 1 part by mass to 100 parts by mass of all the monomers. As a method for supplying the polymerization initiator, can be employed any of an all-at-once method where essentially all the polymerization initiator to be used is placed in a reaction vessel before starting the monomer mixture supply, a continuous supply method, a portionwise supply method, and so forth. From the standpoint of the polymerization procedural ease and process management ease, etc., for example, an all-at-once method can be preferably employed. The polymerization temperature can be, for instance, around 20° C. to 100° C. (typically 40° C. to 80° C.).

As the emulsifier (surfactant), anionic emulsifiers and non-ionic emulsifiers can be used preferably. Examples of anionic emulsifiers include alkylbenzene sulfonates such as sodium dodecylbenzene sulfonate, etc.; alkyl sulfates such as sodium lauryl sulfate, ammonium lauryl sulfate, etc.; sodium polyoxyethylene alkyl ether sulfates, ammonium polyoxyethylene alkyl phenyl ether sulfates, sodium polyoxyethylene alkyl phenyl ether sulfates, sodium polyoxyethylene alkyl sulfosuccinates, polyoxyethylene alkyl phosphoric acid esters, and the like. Examples of non-ionic surfactants include polyoxyethylene alkyl ethers, polyoxyethylene alkyl phenyl ethers, polyoxyethylene aliphatic acid esters, polyoxyethylene-polyoxypropylene block polymers, and the like. Alternatively, can be used a radically-polymerizing emulsifier (reactive emulsifier) having a structure of an anionic or non-ionic emulsifier with a radically-polymerizing group (vinyl group, propenyl group, isopropenyl group, vinyl ether group (vinyloxy group), allylether group (allyloxy group), etc.) introduced therein. Among these emulsifiers, solely one species or a combination of two or more species can be used. The amount of emulsifier used (based on non-volatiles) can be, for instance, about 0.2 part by mass to 10 parts by mass (preferably about 0.5 part by mass to 5 parts by mass) relative to 100 parts by mass of all the monomers.

In the polymerization, as necessary, various conventionally known chain transfer agents (which may be considered as molecular weight-adjusting agents or polymerization degree-adjusting agents) can be used. Such chain transfer agents may be, for example, one, two or more species selected from mercaptans such as dodecylmercaptan (dodecanethiol), glycidylmercaptan, 2-mercaptoethanol, mercaptoacetic acid, 2-ethylhexyl thioglycolate, 2,3-dimercapto-1-propanol and the like. The amount of chain transfer agent used is not particularly limited while it can be selected from a range of, for example, about 0.001 part by mass to 0.5 part by mass relative to 100 parts by mass of all the monomers. With the amount of chain transfer agent used being within this range, it is unlikely to cause adhesive transfer on a glass surface upon removal of the protective sheet, providing excellent non-contaminating property.

The PSA composition can further comprise a crosslinking agent in addition to the acrylic polymer as a base polymer. The type of crosslinking agent is not particularly limited, and a suitable one can be selected and used among various crosslinking agents usually used in the PSA field in accordance with, for example, the type of crosslinking functional group of the functional group-containing monomer, etc. Specific examples include isocyanate-based crosslinking agents such as polyisocyanates, etc., silane-based crosslinking agents, epoxy-based crosslinking agents, oxazoline-based crosslinking agents, aziridine-based crosslinking agents, metal chelate-based crosslinking agents, and melamine-based crosslinking agents. In particular, for their abilities to combine adhesiveness and light releasability at a high level, isocyanate-based crosslinking agents, epoxy-based crosslinking agents and melamine-based crosslinking agents are preferable. As for other advantages, isocyanate-based crosslinking agents and epoxy-based crosslinking agents can preferably form crosslinks with carboxyl group, and also due to their excellent storability, they can be handled easily and are highly acid-resistant as well. Although the amount of crosslinking agent contained in the PSA composition is not particularly limited, it can be about 0.5 part by mass to 10 parts by mass (e.g. 1 part by mass to 7 parts by mass, typically 2 parts by mass to 7 parts by mass) relative to 100 parts by mass of the acrylic polymer.

The PSA composition may further comprise a crosslinking accelerator. The type of crosslinking accelerator can be suitably selected according to the type of crosslinking agent used. The crosslinking accelerator in the present description refers to a catalyst that increases the rate of the crosslinking reaction by a crosslinking agent. Examples of such crosslinking accelerators include tin (Sn)-containing compounds such as dioctyltin dilaurate, dibutyltin dilaurate, dibutyltin diacetate, dibutyltin diacetylacetonate, tetra-n-butyltin and trimethyltin hydroxide; and nitrogen (N)-containing compounds, including amines such as N,N,N′,N′-tetramethylhexanediamine and triethylamine, and imidazoles. Among these, Sn-containing compounds are preferable. The use of these crosslinking accelerators are especially effective when the monomers constituting the acrylic polymer main chain comprise a hydroxyl group-containing monomer as a functional group-containing monomer while an isocyanate-based crosslinking agent is used as a crosslinking agent. The amount of crosslinking accelerator contained in the PSA composition can be, for instance, about 0.001 part by mass to 0.5 part by mass (preferably about 0.001 part by mass to 0.1 part by mass) relative to 100 parts by mass of the acrylic polymer.

The PSA composition may comprise a tackifier as necessary. Conventionally known tackifiers can be used without particular limitations. Examples include terpene-based tackifying resins, phenol-based tackifying resins, rosin-based tackifying resins, aliphatic petroleum resins, aromatic petroleum resins, copolymeric petroleum resins, alicyclic petroleum resins, xylene resins, epoxy-based tackifying resins, polyamide-based tackifying resins, ketone-based tackifying resins, and elastomer-based tackifying resins. Among these, can be used one species solely or a combination of two or more species. When using a tackifier, from the standpoint of obtaining sufficient effects by the tackifier without lowering the properties of the acrylic polymer, its amount used is preferably 50 parts by mass or less (typically 0.1 part by mass to 30 parts by mass) to 100 parts by mass of the acrylic polymer. In view of the adhesiveness, light releasability and non-contaminating property, the PSA composition may be in an embodiment essentially free of a tackifier.

The PSA composition may comprise, in addition to the acrylic polymer, one, two or more species of PSA selected from various known PSA such as rubber-based PSA (natural rubber-based, synthetic rubber-based, a mixture of these, etc.), silicone-based PSA, polyester-based PSA, urethane-based PSA, polyether-based PSA, polyamide-based PSA, fluorine-based PSA, etc. When using these PSA, from the standpoint of preventing the properties of the acrylic polymer from degrading, the amount used is, for example, about 10 parts by mass or less relative to 100 parts by mass of the acrylic polymer. In view of the etching solution penetration resistance, non-contaminating property and light releasability, it is preferably free of these PSA.

The PSA composition may comprise an acid or a base (aqueous ammonia, etc.) used for pH adjustment and so on. Optional components that may be contained in the composition include various additives generally used in the PSA field, such as antistatic agents, slip agents, anti-blocking agents, leveling agents, plasticizers, fillers, colorants (pigments, dyes, etc.), dispersants, stabilizing agents, preservatives, anti-aging agents, etc. The amounts of these additives added can be, as necessary, similar to the amounts usually added to PSA compositions for forming PSA layers (producing protective sheets) for the particular intended use.

The acrylic polymer content in the PSA composition is preferably higher than 50% by mass. In view of being likely to produce adhesiveness suitable for glass etching purpose and for simple molecular designing, it is more preferably 70% by mass or higher (e.g. 90% by mass or higher, typically 95% by mass or higher).

The state of the PSA composition is not particularly limited. It can be in various states such as solvent-based, emulsion-based, aqueous solution-based, active energy ray (UV)-curing type, hot-melt type, etc. Typically, it is prepared by adding other components as necessary to an acrylic polymer solution or dispersion obtained by polymerizing the monomers or their mixture in a suitable solvent. Alternatively, for example, it can be a solvent-based PSA composition obtainable by dissolving an acrylic polymer obtained via emulsion polymerization followed by procedures such as pH adjustment, salting-out, purification and so forth, along with a crosslinking agent and various additives (optional ingredients) as necessary in an organic solvent such as toluene, ethyl acetate, etc.

As the method for providing a PSA layer to a substrate, for instance, can be employed a method (direct method) where the PSA composition is directly provided (typically applied) to a substrate and subjected to a curing treatment, or a method (transfer method) where the PSA composition is provided (typically applied) on top (of a surface (release face)) of a suitable separator (release paper) and subjected to a curing treatment to form a PSA layer on the separator's surface followed by adhering the PSA layer to a substrate to transfer the PSA layer to the substrate. The curing treatment may comprise one, two or more processes selected from drying (heating), cooling, crosslinking, supplemental copolymerization reaction, aging, etc. The curing treatment referred to herein also encompasses, for instance, a process (heating process, etc.) simply to allow a PSA composition containing a solvent to dry, a process simply to cool down (solidify) a heat-melted PSA composition. When the curing treatment comprises two or more processes (e.g. drying and crosslinking), these processes may be performed at once or stepwise.

The PSA composition can be applied, using a commonly-used coater such as a gravure roll coater, reverse roll coater, kiss roll coater, dip roll coater, bar coater, knife coater, spray coater, etc. From the standpoint of accelerating the crosslinking reaction and increasing the productivity, etc., the PSA composition is preferably dried with heating. Depending on the type of support to which the PSA composition is applied, for example, the drying temperature can be around 40° C. to 150° C. After dried, it may be subjected to an aging process of storing it around 40° C. to 60° C. so as to further accelerate the crosslinking reaction. The aging time may be suitably selected according to the desirable crosslinking degree and the rate at which the crosslinking reaction proceeds. It can be, for example, about 12 hours to 120 hours.

The thickness of the PSA layer is not particularly limited, and can be suitably modified according to the purpose. The PSA layer may have a thickness of, for instance, about 1 μm to 100 μm. For glass etching, the thickness is preferably 2 μm or larger, or more preferably 3 μm or larger (e.g. 5 μm or larger, typically 10 μm or larger) while it is 40 μm or smaller (typically 30 μm or smaller). When the PSA layer is too thick, the adhesive strength tends to be excessive while when it is too thin, the sealing ability tends to decrease.

The PSA (layer) constituting the protective sheet has a gel fraction of 60% or higher, preferably 70% or higher, or more preferably 75% or higher. A gel fraction of 60% or higher leads to sufficient cohesive strength, making it unlikely to cause contamination such as adhesive transfer, etc., when the protective sheet is removed. It will be released more lightly as well. Furthermore, it is possible to obtain adhesive strength (i.e. adhesive strength combining sealing ability and light releasability at a high level) suitable for glass etching purpose. Thus, while maintaining the favorable light releasability, it can prevent an etching solution from penetrating from a side of the protective sheet. The upper limit of the gel fraction is not particularly limited while it is preferably 99% or lower, or more preferably 90% or lower. Too high a gel fraction may lead to reduced adhesive strength depending on the constitution of the PSA layer.

The gel fraction can be determined by the following method: A PSA layer (crosslinked PSA (composition)) is wrapped into a pouch with a porous tetrafluoroethylene resin sheet (mass: Wa) of 0.2 μm average pore diameter and the total mass Wb of this pouch is measured. Subsequently the pouch is suspended in toluene and left still at room temperature for seven days. The pouch is then removed and allowed to dry at 120° C. for two hours and the mass Wc of the pouch after dried is measured. The gel fraction (%) of the PSA layer is determined from the next equation:

Gel fraction(%)=(Wc−Wa)/(Wb−Wa)×100

More specifically, a PSA layer (crosslinked PSA (composition)) as a measurement sample weighing approximately 0.1 g is wrapped into a pouch with a porous tetrafluoroethylene resin sheet of 0.2 μm average pore diameter, and the opening is tied with twine. The combined mass Wa (mg) of the porous tetrafluoroethylene resin sheet and the twine is measured in advance. The mass of the pouch (the combined mass of the PSA layer and the wrapping) Wb (mg) is measured. The pouch is placed in a screw vial of volume 50 mL (one screw vial used for each pouch), and the screw vial is filled with toluene. This is set still at room temperature (typically at 23° C.) for seven days, and the pouch is then removed and allowed to dry at 120° C. for two hours. The mass Wc (mg) of the pouch after dried is measured. The gel fraction of the measurement sample is determined by substituting the respective values into the equation. As the porous tetrafluoroethylene resin sheet, can be used trade name “NITOFLON (registered trademark) NTF1122” available from Nitto Denko Corporation. The same method can be used in the worked examples described later.

The PSA composition (PSA layer, PSA) described above has excellent etching solution penetration resistance. The etching solution penetration resistance (the permeability to an etching solution) of such a PSA composition can be evaluated by the following method: In particular, a pH test strip is placed on a glass substrate and a PSA composition is applied to completely cover the pH test strip. The resultant is then allowed to dry to form a PSA layer (layer thickness (film thickness): 100 μm) sealing the pH test strip on the glass substrate. This is placed on a level surface. 2 mL of an etching solution is allowed to drop onto the PSA layer, and the degree of color change of the pH test strip is visually observed and the time required is recorded. The less the color change (the decrease in pH) of the pH test strip and the longer the time required for the change, the greater the etching solution penetration resistance. The size of the pH test strip can be 9 mm by 15 mm while the surface area of the PSA layer formed can be 40 mm by 40 mm. As the etching solution, can be used an aqueous solution (10-fold dilution of an original stock solution) containing a mixture of 1 mol % HF, 2 mol % H₂SO₄, 3 mol % HNO₃ and 2 mol % HPO₄. In the worked examples described later, the same method can be used.

The substrate used in the protective sheet is not particularly limited. A known substrate as film or a sheet can be suitably selected and used. Preferable examples of such a substrate include a substrate (plastic film) formed from a resin material comprising solely one species among polyolefins such as polyethylene (PE), polypropylene (PP), etc.; polyester film such as polyethylene terephthalate (PET), polybutylene terephthalate (PBT), polyethylene naphthalate, etc.; polyvinyl chloride (PVC); polyimide (PI); polyphenylene sulfide (PPS); ethylene-vinyl acetate copolymer (EVA); polytetrafluoroethylene (PTFE) and the like; or a substrate (plastic film) formed of a resin material comprising a blend of two or more species among the above. In particular, for its suitable flexibility, PE, PP and PET are preferable as the resin material. For the excellent balance between the flexibility and acid resistance, PE and PP are more preferable. Since PE and PP films are suitably flexible, when the protective sheet is adhered to an adherend surface that is uneven due to ITO film or an FPC formed thereon and the like, they can preferably conform to the uneven surface. Thus, it is less likely to form channels (a void) for penetration of an etching solution, making itself especially suitable as a substrate in a protective sheet for glass etching. With their excellent acid resistance, PE and PP films can prevent an acidic etching solution such as hydrofluoric acid solution, etc., from swelling and penetrating an adherend surface.

Examples of the film formed from a polyolefin include biaxially oriented polypropylene (OPP) film, low-density polyethylene (LDPE) film, linear low-density polyethylene (LLDPE) film, medium-density polyethylene (MDPE) film, high-density polyethylene (HDPE) film, polyethylene (PE) film comprising a blend of two or more species of polyethylene (PE), PP/PE blend film comprising a blend of polypropylene (PP) and polyethylene (PE), polyolefinic film such as various types of soft polyolefin film, and the like. Among these, solely one species or a combination of two or more species can be used.

The substrate may be of a single layer or have a multi-layer structure (e.g. three-layer structure) consisting of two or more layers. In particular, as the substrate, can be used a resin film (a multi-layer film) having a multi-layer structure comprising films described above. In a multi-layer film, the resin material constituting each layer may comprise solely a single species of resin among those described above, or may be a resin blend comprising two or more species of resin.

Such a substrate (resin film) may be manufactured by suitably employing a conventionally known general film-forming method (e.g., extrusion, inflation, etc.). The surface of the substrate on the side to which a PSA layer is provided (the PSA layer side surface, the surface to be coated with PSA) may be subjected to a treatment to increase adhesion to the PSA layer (a treatment to enhance anchoring of PSA), such as corona discharge treatment, acid treatment, UV irradiation treatment, plasma treatment, primer coating, etc. As a surface treatment (primer treatment) by primer coating, it is preferable to use a primer comprising an acrylic polymer and an isocyanate. The face (back face) of the substrate on the opposite side of the PSA layer side surface may be subjected as necessary to a surface treatment such as antistatic treatment, release treatment, etc. As a release treatment, for example, the face of the substrate that does not contact PSA (the opposite surface of the PSA layer side surface) can be provided with a long-chain alkyl-based or silicone-based release layer so as to reduce the unwinding force of the protective sheet.

The thickness of the substrate can be suitably selected according to the flexural strength (rigidity) of the resin film used. For example, a substrate having a thickness of about 10 μm to 1000 μm can be preferably used. It is preferably about 50 μm to 300 μm (e.g. 80 μm to 300 μm, typically 100 μm to 200 μm). As the thickness of the substrate increases, the flexural strength of the protective sheet increases. Accordingly, when the protective sheet is adhered to an adherend or removed from the adherend, the protective sheet becomes unlikely to wrinkle, float or twist. Since the light releasability tends to increase as well, the workability (handling properties) is increased further. Moreover, etching solutions tend to be readily prevented from swelling and penetrating (soaking) the protective sheet surface.

The PSA layer side surface and/or the back face of the substrate preferably has an arithmetic mean surface roughness of 1 μm or smaller, or more preferably 0.05 μm to 0.75 μm (e.g. about 0.05 μm to 0.5 μm, typically about 0.1 μm to 0.3 μm). With such a constitution, the smoothness of the PSA (layer) surface (surface to be adhered) also increases and stress is relatively evenly distributed when peeled away from an adherend surface, allowing avoidance of an event of the PSA being partially torn off by some local stress concentration and left on the adherend side, etc. When the substrate has a smoother surface (has an arithmetic mean surface roughness within the numerical ranges), the PSA layer is less likely to form a void due to floating, etc., at the interface with the adhered, reducing the risk of an etching solution penetrating the protective sheet from the void.

The protective sheet preferably has an adhesive strength to glass of 0.05 N/20 mm or greater (e.g. 0.1 N/20 mm or greater, typically 0.2 N/20 mm or greater). By this, good adhesive strength can be obtained, and for example, disadvantages such as the protective sheet peeling off during an etching treatment can be prevented more preferably. The adhesive strength is preferably 3 N/20 mm or less (e.g. 2.5 N/20 mm or less, typically 2 N/20 mm or less). By this, the adhesive strength does not become excessively high, making it possible to preferably prevent disadvantages such as damaging adherends (typically breaking glass, peeling off of ITO film, etc.) from occurring upon removal of the protective sheet after an etching treatment.

The adhesive strength (180° peel adhesive strength) to glass can be measured by the following method: A protective sheet subjected to a measurement is cut to a 20 mm by 60 mm rectangle with the MD direction being in the length direction to prepare a test piece. The test piece is adhered over its PSA layer side to a glass substrate with a 2 kg roller moved back and forth once. This is stored in an environment at 25° C., 50% RH. Subsequently, using a tensile tester (available from Shimadzu Corporation, trade name “TENSILONE”), based on JIS Z0237, in an environment at 25° C., 50% RH, at a peel angle of 180° and a tensile speed of 300 mm/min, the 180° peel adhesive strength to glass is measured. For the glass substrate, can be used trade name “MICROSLIDE GLASS” available from Matsunami Glass Ind., Ltd. The same method can be employed in the worked examples described later.

The protective sheet has excellent etching solution penetration resistance. Such etching solution penetration resistance can be evaluated by the following method. The same method can be employed in the worked examples described later.

(1) Evaluation of Etching Solution Penetration from Protective Sheet Surface

A pH test strip is placed on a glass substrate and a protective sheet is adhered to completely cover and seal the pH test strip. After this is placed on a level surface, 2 mL of an etching solution is allowed to drop onto the protective sheet, and the degree of color change of the pH test strip is visually observed and the time required is recorded. The less the color change (the decrease in pH) of the pH test strip and the longer the time required for the change, the greater the etching solution penetration resistance. The size of the pH test strip can be 9 mm by 15 mm while the surface area of the protective sheet can be 40 mm by 40 mm. As the etching solution, can be used an aqueous solution (10-fold dilution of an original stock solution) containing a mixture of 1 mol % HF, 2 mol % H₂SO₄, 3 mol % HNO₃ and 2 mol % HPO₄.

(2) Evaluation of Etching Solution Penetration from Protective Sheet Sides

In the same manner as (1) above, a protective sheet is adhered to a glass substrate. This is placed in a container, completely immersed in an etching solution, and left immersed for one hour. The presence of any erosion (deformation) on the area to which the protective sheet is adhered on the glass substrate is visually inspected via the protective sheet surface. For the etching solution, the same one as (1) above can be used.

It is desirable that the protective sheet provides excellent peeling efficiency (anti-tearing property, adherend-non-invasive property). The peeling efficiency can be evaluated by the following method: In particular, a glass substrate is obtained, and to this glass substrate, a protective sheet (20 mm by 60 mm (cut with the MD direction being in the length direction)) is adhered. Adhesion is carried out with a 2 kg roller moved back and forth once. This is placed in a container and an etching solution (e.g. an aqueous solution containing a mixture of 1 mol % HF, 2 mol % H₂SO₄, 3 mol % HNO₃ and 2 mol % HPO₄) is added until the protective sheet is completely immersed, and left immersed in the etching solution for one hour. Subsequently, the etching solution is eliminated by washing, and the protective sheet is peeled away from the glass substrate by hand. The peeling efficiency can be evaluated based on the following. It is noted that the same method can be employed in the worked examples described later.

Good: No alterations were found either in the protective sheet or in the glass substrate upon removal of the sheet.
Poor: Some tearing of the protective sheet or damage to the glass substrate was found upon removal of the sheet.

The protective sheet according to the first embodiment can be used as a protective sheet that is adhered to a desirable area of an adherend (typically a glass substrate) to protect the area. The PSA used in this protective sheet is unlikely to undergo alteration, dissolution or the like even when it is exposed to an etching solution. On an area not to be exposed to an etching solution, it can surely prevent etching solution penetration and protect the surface. In short, the protective sheet has excellent etching solution penetration resistance as well as great non-contaminating properties while it releases lightly, it does not damage the protective sheet itself or the adherend. Thus, when etching an adherend surface, the protective sheet can be preferably used to mask an area where effects by the etching solution should be avoided. In particular, it is preferably used on an adherend having ITO film formed on its surface, such that before an etching treatment is performed on part of an adherend surface of which only the upper face and sides are exposed, the protective sheet is adhered over its PSA layer side to a non-etching area on one face of the adherend.

The protective sheet for glass etching (or abbreviated to the protective sheet hereinafter) according to the second embodiment is described next.

The protective sheet disclosed herein comprises a substrate and a PSA layer provided at least on one face of the substrate. A typical constitution example of the protective sheet is schematically illustrated in FIG. 1. This protective sheet 10 comprises a resin substrate sheet 1 and a PSA layer 2 provided on a first face (one face) thereof. When used, before etching glass, this protective sheet 10 is used by being adhered over the PSA layer 2 side to a prescribed area (an area to be protected, typically an area where effects by an etching solution should be avoided (or a “non-etching area” hereinafter)) of the adherend (typically a glass substrate). This allows protection of the non-etching area from an etching solution. Typically, as shown in FIG. 2, prior to use (i.e. before adhered to the adherend), protective sheet 10 may typically be present in such a state where the surface (adhering face) of the PSA layer 2 is protected with a release liner 3 having a release face at least on the PSA layer 2 side. Alternatively, it may be present in such a state where, with substrate 1 having a release face on the other face (the back face of the surface on which PSA layer 2 is provided), protective sheet 10 is wound in a roll so that the other face contacts the PSA layer 2 and protects the surface. The protective sheet may be an adhesively double-faced PSA sheet comprising a PSA layer provided on each face of a substrate. In this case, each PSA layer may be in a state where its face to be adhered to an adherend is protected with a release liner having a release face at least on the PSA layer side. As long as the protective sheet is in a sheet form, it may be present as a roll or as a single plate with a separator, etc.

The protective sheet disclosed herein has a strength T_{M25} at 10% stretch in the MD at a temperature of 25° C. and a strength T_{T25} at 10% stretch in the TD perpendicular to the MD at the same temperature, of which at least one value is 1 N/cm to 25 N/cm. It is more preferable that both T_{M25} and T_{T25} satisfy the numerical range of the strength values at 10% stretch. The strength value(s) at 10% stretch is preferably 3 N/cm or greater (e.g. 5 N/cm or greater, typically 8 N/cm or greater). With the strength value (T_{M25}, T_{T25}) at 10% stretch being 1 N/cm or greater, the protective sheet has suitable hardness. Thus, when adhering it to an adherend, it is unlikely to wrinkle, float or twist, making it easy to apply. Since the protective sheet is at or above a certain level of strength, disadvantages such as tearing of the protective sheet upon removal can be prevented from occurring. It also allows light release, leading to excellent workability. A strength value (T_{M25}, T_{T25}) at 10% stretch less than 1 N/cm is not preferable because the protective sheet being too soft causes excessive stress onto the adherend during its removal. The strength value(s) (T_{M25}, T_{T25}) at 10% stretch is preferably 22 N/cm or less (e.g. N/cm or less, typically 18 N/cm or less). With the strength value (T_{M25}, T_{T25}) at 10% stretch being 25 N/cm or less, the protective sheet does not turn out excessively hard. Thus, even when the adherend has an uneven surface, it can conform to the surface structure and provides excellent adhesion. Accordingly, at sides of the protective sheet, there is no formation of a void such as wrinkles or the like through which an etching solution could penetrate, thereby increasing the sealing ability.

The strength (tensile strength) at 10% stretch refers to a tensile strength measured when, based on JIS K7127, at a temperature of 25° C., a 10 mm wide test piece cut out in each measurement direction (T_{M25}, T_{T25}) is stretched by 10% at a tensile speed of 300 mm/min. For the strength (tensile strength) at 10% stretch, for instance, can be used a value obtainable by the measurement method for the strength at 10% stretch described later in the worked examples.

It is preferable that the protective sheet disclosed herein has an MD flexural rigidity value D_{M25} at a temperature of 25° C. and a TD flexural rigidity value D_{T25} at the same temperature, of which at least one value is 1.5×10⁻⁵ Pa·m³ or greater (e.g. 2×10⁻⁵ Pa·m³ or greater, typically 3×10⁻⁵ Pa·m³ or greater). At least one of D_{M25} and D_{T25} is preferably 10×10⁻⁵ Pa·m³ or less (e.g. 9.5×10⁻⁵ Pa·m³ or less, typically 9×10⁻⁵ Pa·m³ or less). It is more preferable that each of D_{M25} and D_{T25} satisfies the numerical range of flexural rigidity values. With the flexural rigidity value D_{M25} or D_{T25} being within these ranges, the protective sheet has suitable rigidity (flexural strength). Thus, when placing the protective sheet at a prescribed location of an adherend, the protective sheet is unlikely to twist or wrinkle, providing excellent workability. When removing the protective sheet from the adherend, the flexural strength (a force to work against flexural deformation to restore its original shape) of the protective sheet can be utilized as part of peel strength, thereby providing excellent workability. For applying the protective sheet to an adherend surface when sides of the adherend are up for an etching treatment, since the protective sheet has suitable rigidity, it is unlikely to fall at the protective sheet edges. Thus, it is unnecessary to make the protective sheet to exactly match the surface dimensions of the adherend. In view of this also, it is highly workable. When D_{M25} or D_{T25} is too large, even if the protective sheet is adhered to an adherend, it tends to become less likely to conform to the surface structure of the adherend, resulting in insufficient adhesion of the protective sheet.

When the substrate has a thickness h and a Poisson's ratio V while the protective sheet has a MD tensile modulus E_{M25} at a temperature of 25° C., the flexural rigidity value D_{M25} is determined by equation:

D_{M25}=E_{M25}h³/12(1−V²)

The flexural rigidity value D_{T25} can be determined using a TD tensile modulus E_{T25}, in the same manner as the D_{M25}. Since the flexural rigidity values of the PSA layer are significantly smaller than the flexural rigidity values of the substrate, the flexural rigidity values of the protective sheet may be approximately equal to the flexural rigidity values of the substrate. Thus, the flexural rigidity values D_{M25} and D_{T25} refer to values converted into per cross-sectional surface area of the substrate constituting the protective sheet. The cross-sectional area of a substrate is determined based on the thickness of the substrate. The substrate's thickness h is a value obtained by subtracting the thickness of the PSA layer from the actual thickness of the protective sheet. The Poisson's ratio V is a value (dimensionless number) determined by the material of the substrate. When the material is a resin, 0.35 is usually used for the V value. More specifically, for the flexural rigidity values D_{M25} and D_{T25}, can be used values obtainable by the measurement method described later in the worked examples.

It is preferable that the protective sheet disclosed herein has a MD tensile modulus E_{M25} at a temperature of 25° C. and a TD tensile modulus E_{T25} at the same temperature, of which at least one value is 50 MPa or higher (e.g. 100 MPa or higher, typically 150 MPa or higher). This protective sheet is likely to exhibit excellent handling properties in a room temperature environment. The E_{M25} and E_{T25} values of the protective sheet can be 9000 MPa or lower (e.g. 8000 MPa or lower, typically 4000 MPa or lower). Such a protective sheet is likely to have suitable flexural rigidity values D_{M25} and D_{T25}. Thus, it is likely to provide excellent adhesion.

The tensile moduli E_{M25} and E_{T25} of the protective sheet can be determined each from linear regression of a stress-strain curve obtained by cutting out a test piece of a prescribed width along the MD or TD from the protective sheet, and elongating the test piece in the MD or TD at a tensile speed of 300 mm/min at a temperature of 25° C. based on JIS K7161. For example, can be used values measured at a prescribed temperature by the tensile modulus measurement method described later in the worked examples. Since the tensile moduli of the PSA layer are significantly smaller than the tensile moduli of the substrate, the tensile moduli of the protective sheet may be approximately equal to the tensile moduli of the substrate. Thus, in the present description, the tensile moduli E_{M25} and E_{T25} of a protective sheet refer to values converted into per cross-sectional surface area of the substrate constituting the protective sheet. The cross-sectional area of a substrate is determined based on the thickness of the substrate. The substrate's thickness is a value obtained by subtracting the thickness of the PSA layer from the actual thickness of the protective sheet.

The protective sheet preferably has a deflection angle of 60° to 80° (e.g. 65° to 78°, typically 67° to 77°). With the deflection angle being 60° or larger, the protective sheet can obtain suitable rigidity (flexural property). Thus, when adhering the protective sheet, wrinkling, floating and twisting tend to be readily prevented from occurring. Upon its removal, tearing of the tape and heavy release tend to be readily prevented as well. Thus, it provides excellent workability. With the deflection angle being 80° or smaller, the protective sheet does not become too flexurally strong or rigid. Thus, it can sufficiently conform to a surface structure of an adherend having a step such as ITO film or the like formed thereon, thereby increasing the sealing ability.

The deflection angle can be measured by the following method: With reference to FIG. 3, a 100 mm by 50 mm protective sheet 10 is obtained and fixed on a test board 40 such that from a side view, a section of protective sheet 10 measuring 60 mm in the length direction is on the test board 40 having a level surface while the remaining 40 mm section over the length direction extends laterally from an edge of test board 40. It can be fixed by adhering the entire bottom face of the 60 mm section in the length direction via polyester PSA tape (“No. 31B” available from Nitto Denko Corporation) or by placing a weight on the 60 mm section in the length direction. The angle A° formed by the extending section of protective sheet 10 relative to the vertical direction is measured. The angle A° can be recorded as the deflection angle. When the deflection is not straight, but curved or so, the deflection angle A° can be defined as an angle formed between the segment connecting the lower edge of the extending section of protective sheet 10 to the upper edge of the side surface of test board 40 and the vertical direction.

The substrate used in the protective sheet is not particularly limited, and a known substrate in a film form or a sheet form can be suitably selected and used. Preferable examples of such a substrate include polyolefin resins such as polyethylene (PE), polypropylene (PP), etc.; polyamide resin (PA), polycarbonate resin (PC), polyurethane resin (PU), ethylene vinyl acetate resin (EVA), fluorine resin, and acrylic resin. The substrate may be formed from a resin material comprising solely one species among these resins or from a resin material comprising a blend of two or more species. In particular, polyolefin resins such as PE, PP, etc., having suitable flexibility and excellent acid resistance are preferable. As polyolefin resin is suitably flexible, when the protective sheet is adhered to an adherend surface that is uneven with ITO film formed thereon, it can preferably conform to such an uneven surface. Thus, it is be less likely to form channels (a void) for etching solution penetration, making itself preferable as a substrate in a protective sheet for glass etching. Due to its excellent acid resistance, polyolefin resin readily prevents an acidic etching solution such as hydrofluoric acid solution, etc., from swelling and penetrating an adherend surface. Also from this standpoint, it is preferable as a substrate in a protective sheet for glass etching. The substrate may be of a single layer or have a multi-layer structure (e.g. three-layer structure) consisting of two or more layers. In resin film having a multi-layer structure, the resin material constituting each layer may comprise solely one species of resin described above or a blend of two or more species of resin.

In a preferable embodiment, the substrate may be a polyolefin resin film of a single layer or multiple layers. Herein, the term polyolefin resin film refers to a film wherein the primary component among the resin components constituting the film is a polyolefin resin (i.e. a resin comprising a polyolefin as the primary component). The resin components in the film may essentially consist of a polyolefin resin. Alternatively, the film may be formed from a resin material comprising, as the resin components, a polyolefin resin as the primary component (e.g., a resin component accounting for greater than 50% by mass) and an additional resin component (e.g., PA, PC, PU, EVA, etc.) other than a polyolefin resin. As the polyolefin resin, can be used solely a single species of polyolefin or a combination of two or more species of polyolefin. The polyolefin may be, for example, an α-olefin homopolymer, a copolymer of two or more species of α-olefin, a copolymer of one, two or more species of α-olefin and a vinyl monomer, or the like. Specific examples include polyethylene (PE), polypropylene (PP), ethylene-propylene copolymers such as ethylene-propylene rubber (EPR), ethylene-propylene-butene copolymers, ethylene-ethyl acrylate copolymers, and the like. Either a low-density (LD) polyolefin or a high-density (HD) polyolefin can be used. Examples of such a polyolefin resin film include polyolefin resin films such as biaxially oriented polypropylene (OPP) film, low-density polyethylene (LDPE) film, linear low-density polyethylene (LLDPE) film, medium-density polyethylene (MDPE) film, high-density polyethylene (HDPE) film, polyethylene (PE) film as a blend of two or more different polyethylene (PE) species, PP/PE blend film as a blend of a polypropylene (PP) and a polyethylene (PE), various soft polyolefin film species and the like. Among these, solely one species or a combination of two or more species can be used.

The PP may be various polymers (propylene-based polymers) obtained from propylene as a primary monomer (a primary monomeric unit, i.e., a component accounting for higher than 50% by mass of the total amount of monomers). The concept of the propylene-based polymer referred to herein encompasses, for instance, the following polypropylenes:

Propylene homopolymers (i.e. homopolypropylenes). For example, isotactic polypropylenes, syndiotactic polypropylenes, atactic polypropylenes.

Random copolymers of propylene and other α-olefin(s) (typically, one, two or more species selected from ethylene and α-olefins having 4 to 10 carbons) (random polypropylenes). For example, a random polypropylene in which 96 mol % to 99.9 mol % of propylene and 0.1 to 4 mol % of other α-olefin(s) (preferably ethylene and/or butane) are randomly copolymerized.

Copolymers in which propylene and other α-olefin(s) (typically, one, two or more species selected from ethylene and α-olefins having 4 to 10 carbons) are copolymerized in blocks (block polypropylenes). Such a block polypropylene may further comprise, as a secondary product, a rubber formed comprising propylene and at least one of the other α-olefins as the components. For example, a block polypropylene comprising a polymer in which 90 mol % to 99.9 mol % of propylene and 0.1 mol % to 10 mol % of other α-olefin(s) (preferably ethylene and/or butane) are copolymerized in blocks, and further comprising, as a secondary product, a rubber comprising propylene and at least one of the other α-olefins as the components.

The PP resin may be a resin comprising a propylene-based polymer described above as the primary component among the resin components, and further comprising other polymer(s) blended therewith as secondary component(s). The other polymer(s) may be one, two or more species of polyolefin comprising an α-olefin other than propylene, for instance, an α-olefin having 2 or 4 to 10 carbons, as the primary monomer (primary monomeric constituent, i.e. a component accounting for higher than 50% by mass of the total amount of monomers). The PP resin may have a composition comprising at least PE as the secondary component. The PE content can be, for instance, 3 parts by mass to 50 parts by mass (typically 5 parts by mass to 30 parts by mass) to 100 parts by mass of PP. The PP resin may essentially consist of PP and PE as the resin components. The PP resin may comprise at least PE and EPR as secondary components (e.g. the PP resin may essentially consist of PP, PE and EPR as the resin components). In this case, the EPR content can be, for instance, 3 parts by mass to 50 parts by mass (typically 5 parts by mass to 30 parts by mass) to 100 parts by mass of PP.

The PE may be an ethylene homopolymer, or a copolymer of ethylene as the primary monomer and other α-olefin(s) (e.g. an α-olefin having 3 to 10 carbons). Preferable examples of the α-olefin include propylene, 1-butene, 1-hexene, 4-methyl-1-pentene, 1-octene and the like. Any of low-density polyethylene (LDPE), linear low-density polyethylene (LLDPE), and high-density polyethylene (HDPE) can be used. For example, an LDPE and/or an LLDPE can be preferably used.

Alternatively, as the substrate, can be used a polyolefin resin film that is essentially free of halogen atoms while being as flexible, heat-resistant and flame-resistant as polyvinyl chloride (PVC). A preferable polyolefin resin film may comprise, for example, an olefinic polymer alloy and a thermoplastic resin containing a carbonyl (C═O) group in its molecular structure (a carbonyl group-containing thermoplastic resin).

The olefinic polymer alloy is a component mainly to suppress thermal deformation of the substrate, and preferably comprises an ethylenic component and a propylenic component. The embodiment of the polymer alloy is not particularly limited. Polymer alloys in various embodiments can be used, such as a polymer blend in which two or more polymer species are physically mixed, a block copolymer or a graft copolymer in which two or more polymer species are covalently bonded, an IPN (interpenetrating polymer network) structure in which two or more polymer species are intertwined without being covalently bonded to each other, and so on. It may be either a miscible polymer alloy as a homogeneous mixture of two or more polymer species or an immiscible polymer alloy in which two or more immiscible polymer species are forming separate phases.

Examples of such an olefinic polymer alloy include a polymer blend of a polypropylene (a homo-polypropylene, random polypropylene) and a polyethylene (including a copolymer of ethylene and a small amount of an α-olefin), and a propylene/ethylene copolymer, a three-component copolymer consisting of propylene, ethylene and another α-olefin besides these (with other examples of the α-olefin including 1-butene, 1-pentene, 1-hexene, 4-methyl-1-pentene, 1-heptene, 1-octene or the like, among which 1-butene is preferable).

When the olefinic polymer alloy is a copolymer, it is preferably a multiple-stepwise-polymerized olefinic copolymer (preferably an ethylene/propylene copolymer) which has been polymerized by multistep polymerization involving two or more steps. Examples of such a multiple-stepwise-polymerized olefinic copolymer include polymer alloys described in Japanese Patent Application Publication No. 2001-192629. That is, the polymer alloy is a polypropylene (1st step)/propylene-ethylene copolymer (2nd step and beyond) copolymer obtained by carrying out the first polymerization step with a monomer mixture comprising propylene as the primary component followed by copolymerizing propylene and ethylene in the second step and beyond. The first polymerization step is preferably carried out in the presence of a titanium compound catalyst and an organoaluminum compound catalyst. The second polymerization step and beyond are preferably carried out in the presence of the titanium-containing polyolefin resulting from the first step and an organoaluminum compound catalyst. Examples of the titanium compound catalyst include a globular solid catalyst of 1 μm to 30 μm average particle diameter obtainable by pulverizing titanium(III) chloride and magnesium chloride together and treating the resultant with n-butyl orthotitanate, 2-ethyl-hexanol, ethyl p-tolylate, silicon tetrachloride, diisobutyl phthalate, etc. Examples of an organoaluminum compound catalyst include alkylaluminums such as triethylaluminum, etc. In the polymerization tank, can be further added as an electron donor a silicon compound such as diphenyl dimethoxysilane and the like, or an iodine compound such as ethyl iodide and the like.

From the standpoint of suppressing thermal deformation, the olefinic polymer alloy preferably has a dynamic storage elastic modulus (E′) of 40 MPa or higher, but lower than 180 MPa (e.g. 45 MPa to 160 MPa) at 80° C. while having a dynamic storage elastic modulus (E′) of 12 MPa or higher, but lower than 70 MPa (e.g. 15 MPa to 65 MPa) at 120° C. In view of the surface structure conformability and workability at or near room temperature, it preferably has a dynamic storage elastic modulus (E′) of 200 MPa or higher, but lower than 400 MPa at 23° C. The dynamic storage elastic modulus (E′) is a value obtained by preparing a test piece (0.2 mm thick, 10 mm wide, 20 mm long) of a polymer alloy and analyzing the temperature variant behavior of the dynamic storage elastic modulus of the test piece, using DMS200 (available from Seiko Instruments Inc.) as a measurement device under prescribed conditions (e.g. measurement method: tensile mode, heating rate: 2° C./min, frequency: 1 Hz). Examples of such a polymer alloy include trade names “CATALLOY KS-353P”, “CATALLOY KS-021P”, “CATALLOY C200F”, “CATALLOY Q-200F” available from SunAllomer Ltd., and the like.

The carbonyl group-containing thermoplastic resin is used to provide the substrate with suitable flexibility and good extensibility, and contains a carbonyl (C═O) group in its molecular structure. When the polyolefin resin film comprises an inorganic flame retardant, it may act as a component that activates the inorganic flame retardant's effect to provide flame resistance. As such a thermoplastic resin, a preferable soft polyolefinic resin comprises a carbonyl group in its molecular structure, with examples including an ethylene/vinyl ester-based copolymer and ethylene/unsaturated carboxylic acid-based copolymer each synthesized with a monomer or comonomers being a vinyl ester compound and/or an α,β-unsaturated carboxylic acid or its derivative; and their metal salts, etc. The melting point of such a thermoplastic resin is not particularly limited while it is preferably 120° C. or below (typically 40° C. to 100° C.). The melting point can be measured with a differential scanning calorimeter (DSC).

Examples of the vinyl ester compound in the ethylenic copolymer or its metal salt include lower-alkyl esters of vinyl alcohols such as vinyl acetate, etc. Examples of α,β-unsaturated carboxylic acids and their derivatives include unsaturated carboxylic acids and their anhydrides such as acrylic acid, methacrylic acid, maleic acid, fumaric acid, maleic anhydride, itaconic anhydride, etc.; and unsaturated carboxylic acid esters such as methyl (meth)acrylate, ethyl (meth)acrylate, propyl (meth)acrylate, isopropyl (meth)acrylate, n-butyl (meth)acrylate, cyclohexyl (meth)acrylate, stearyl (meth)acrylate, lauryl (meth)acrylate, 1-methyl maleate, 1-ethyl maleate, diethyl maleate, 1-methyl fumarate, glycidyl (meth)acrylate, etc. Among these, can be used one species solely or a combination of two or more species. In particular, alkyl (meth)acrylates are preferable, with ethyl acrylate being more preferable.

Preferable examples of ethylene-vinyl ester-based copolymers and ethylene-unsaturated carboxylic acid-based copolymers include ethylene-acrylic acid copolymers, ethylene-methacrylic acid copolymers, ethylene-ethyl acrylate copolymers, ethylene-acrylic acid-ethyl acrylate copolymers, ethylene-vinyl acetate copolymers, ethylene-vinyl acetate-ethyl acrylate copolymers, ethylene-glycidyl methacrylate copolymers, ethylene-glycidyl methacrylate-ethyl acrylate copolymers and their metal salts. Among these, can be used one species solely or a combination of two or more species.

Preferably, the polyolefin resin film comprises an inorganic flame retardant. Examples of such inorganic flame retardants include metal hydroxides such as aluminum hydroxide, magnesium hydroxide, zirconium hydroxide, calcium hydroxide, barium hydroxide, etc.; metal carbonates such as basic magnesium carbonate, magnesium-calcium carbonate, calcium carbonate, barium carbonate, dolomite, etc.; metal hydrates (hydrates of metallic compounds) such as hydrotalcite, borax, etc.; inorganic metallic compounds such as barium metaborate, magnesium oxide, etc. Among these, can be used one species solely or a combination of two or more species. In particular, metal hydroxides such as aluminum hydroxide, magnesium hydroxide, zirconium hydroxide, calcium hydroxide, barium hydroxide, etc., as well as basic magnesium carbonate and hydrotalcite are preferable.

Preferably, the inorganic flame retardant has a surface treated with a silane-based coupling agent. This can increase properties such as flexibility, heat resistance, flame resistance, etc. Specific examples of such a silane-based coupling agent include vinyltriethoxysilane, vinyl-tolyl(2-methoxy-ethoxy)silane, γ-methacryloxypropyltrimethoxysilane, γ-aminopropyltrimethoxysilane, γ-aminopropyltriethoxysilane, N-phenyl-γ-aminopropyltrimethoxysilane, N-β-(aminoethyl)-γ-aminopropyltrimethoxysilane, N-β-(aminoethyl)-γ-aminopropyltriethoxysilane, N-phenyl-γ-aminopropyltriethoxysilane, β-(3,4-epoxycyclohexyl)ethyltrimethoxysilane, glycidoxypropyltrimethoxysilane, and γ-mercaptopropyltrimethoxysilane. Among these, can be used one species solely or a combination of two or more species.

The surface treatment method for the inorganic metallic compound by a silane-based coupling agent is not particularly limited. For instance, a conventionally known method can be suitably employed, such as a dry treatment method, a wet treatment method, etc. While the amount of the silane-based coupling agent to be applied to an inorganic metallic compound surface cannot be generalized as it can be different depending on the type of coupling agent, the type and specific surface area of inorganic metallic compound, etc., it is usually about 0.1 parts by mass to 5.0 parts by mass (e.g. 0.3 parts by mass to 3.0 parts by mass) to 100 parts by mass of the inorganic metallic compound.

It is preferable from the standpoint of combining heat resistance and flame resistance that the ratio of the olefinic polymer alloy to the carbonyl group-containing thermoplastic resin is 90:10 to 20:80 by mass. When an inorganic flame retardant is added, from the standpoint of increasing the flame resistance while maintaining the flexibility, its amount added is preferably about 10 parts by mass to 200 parts by mass (e.g. 20 parts by mass to 100 parts by mass) relative to 100 parts by mass of the polymers (e.g. a total of the multiple-stepwise-polymerized olefin copolymer and the carbonyl group-containing thermoplastic resin).

The resin can contain, as necessary, components suitable for the intended use of the protective sheet. For example, additives such as light stabilizers including radical scavengers and UV absorbers, antioxidants, antistatic agents, colorants (dyes, pigments, etc.), fillers, slip agents and anti-blocking agents may be suitably added. Examples of light stabilizers include those containing benzotriazoles, hindered amines, benzoates, etc., as active ingredients. Examples of antioxidants include those containing alkylphenols, alkylene bisphenols, thiopropylene acid esters, organic phosphates, amines, hydroquinones, hydroxylamines, etc., as active ingredients. Among these additives, solely one species or as a combination of two or more species can be used. Depending on the intended use of the protective sheet (e.g. for masking during plating), the amounts of these additives may be about the same as conventional amounts added to plastic films used as substrates for the particular intended use.

Such a substrate (resin film) may be manufactured by suitably employing a conventionally known general film-forming method (e.g., extrusion, inflation, etc.). The surface of the substrate on the side to which a PSA layer is provided (the PSA layer side surface, the surface to be coated with PSA) may be subjected to a treatment to increase adhesion to the PSA layer (a treatment to enhance anchoring of PSA), such as corona discharge treatment, acid treatment, UV irradiation treatment, plasma treatment, primer coating, etc. As a surface treatment (primer treatment) by primer coating, it is preferable to use a primer comprising an acrylic polymer and an isocyanate. The face (back face) of the substrate on the opposite side of the PSA layer side surface may be subjected as necessary to a surface treatment such as antistatic treatment, release treatment, etc. As a release treatment, for example, the face of the substrate that does not contact PSA (the opposite surface of the PSA layer side surface) can be provided with a long-chain alkyl-based or silicone-based release layer so as to reduce the unwinding force of the protective sheet.

The thickness of the substrate can be suitably selected according to the flexural strength (rigidity) of the resin film used, etc. For example, a substrate having a thickness of about 10 μm to 1000 μm can be used. The thickness of the substrate is preferably about 50 μm to 300 μm (e.g. 100 μm to 300 μm, typically 120 μm to 200 μm). With increasing thickness of the substrate, the protective sheet becomes flexurally stronger. Thus, when adhering the protective sheet to an adherend or removing the protective sheet from the adherend, it tends to be less susceptible to wrinkling, floating or twisting. Since the light releasability also tends to be greater, the workability (handling properties) is increased further. When a side of an adherend is up for an etching treatment and the protective sheet is adhered to a surface of the adherend, since the protective sheet has a suitable thickness, it is unlikely to fall at edges of the protective sheet. Furthermore, etching solutions tend to be readily prevented from swelling and penetrating the protective sheet surface. When the protective sheet is too thick, even if the protective sheet is adhered to an adherend, it tends to be less conformable to a surface structure of the adherend. Thus, the adhesion of the protective sheet may be insufficient.

The PSA layer side surface and/or the back face of the substrate preferably has an arithmetic mean surface roughness of 1 μm or smaller, or more preferably 0.05 μm to 0.75 μm (e.g. about 0.05 μm to 0.5 μm, typically about 0.1 μm to 0.3 μm). With such a constitution, the smoothness of the PSA (layer) surface (surface to be adhered) also increases and stress is relatively evenly distributed when peeled away from an adherend surface, allowing avoidance of an event of the PSA being partially torn off by some local stress concentration and left on the adherend side, etc. When the substrate has a smoother surface (has an arithmetic mean surface roughness within the numerical ranges), the PSA layer is less likely to form a void due to floating, etc., at the interface with the adhered, reducing the risk of an etching solution penetrating the protective sheet from the void.

As described above, the strength values at 10% stretch, flexural rigidity values and tensile moduli at a prescribed temperature of the substrate may be approximately equal to the strength values at 10% stretch, flexural rigidity values and tensile moduli at a prescribed temperature of the protective sheet. Thus, a protective sheet that satisfies each of these properties can be obtained, for instance, by selecting the type (e.g. components and their ratio) and thickness of substrate, and so on.

The type of PSA constituting the PSA layer provided on the substrate is not particularly limited. For example, it can be a PSA layer constituted to comprise one, two or more species of PSA selected from various known PSA such as acrylic PSA (which refers to a PSA comprising an acrylic polymer as a base polymer (a primary component among polymers); the same applies hereinafter), rubber-based PSA (natural rubber-based, synthetic rubber-based, a mixture of these, etc.), silicone-based PSA, urethane-based PSA, polyether-based PSA, fluorine-based PSA, etc. Among these, for the excellent resistance to etching solutions, acrylic PSA, rubber-based PSA and silicone-based PSA are preferable. Similarly, the PSA composition used to form the PSA (layer) is not particularly limited. A composition comprising polymers constituting a PSA described above at a suitably-selected ratio can be used.

In particular, the PSA constituting the PSA layer is preferably an acrylic PSA comprising an acrylic polymer as a base polymer (a primary component among the polymers, primary adhesive ingredient). The term “acrylic polymer” typically refers to a polymer (copolymer) obtained by polymerizing starting monomers (a single monomer species or a monomer mixture) that comprise an alkyl (meth)acrylate as a primary monomer and may further comprise an optional monomer copolymerizable with the primary monomer. The term “(meth)acrylate” refers collectively to acrylate and methacrylate. Likewise, the term “(meth)acryloyl” refers collectively to acryloyl and methacryloyl, and the term “(meth)acryl” refers collectively to acryl and methacryl.

As the alkyl (meth)acrylate, can be preferably used a compound represented by the formula:

CH₂═CR¹COOR²

Herein, R¹ in the formula is a hydrogen atom or a methyl group. R² is an alkyl group having 1 to 20 carbon atoms (hereinafter, such a range of the number of carbon atoms may be represented by “C₁₋₂₀”). From the standpoint of the storage elastic modulus of the PSA, it may be an alkyl (meth)acrylate with R² being a C₁₋₁₄ (e.g. C₁₋₁₀) alkyl group. The alkyl group is linear or branched.

Examples of the alkyl (meth)acrylate having a C₁₋₂₀ alkyl group include methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, pentyl (meth)acrylate, isopentyl (meth)acrylate, hexyl (meth)acrylate, heptyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate and eicosyl (meth)acrylate. Among these, can be used one species solely or a combination of two or more species. Among these, n-butyl acrylate, n-butyl methacrylate and 2-ethylhexyl acrylate are preferable. For example, it can be an acrylic polymer in which one, two or more species among these are copolymerized in total at a ratio exceeding 50% by mass (e.g. 60% by mass or greater, but 99% by mass or less, typically 70% by mass or greater, but 98% by mass or less).

As the primary monomer, it is preferable to use a monomer with R² in the formula being an alkyl group having 6 or more (e.g. 7 or more, typically 8) carbons. As the number of carbons in the alkyl group increases, the hydrophobicity increases, and it can be expected to produce effects of preventing penetration of etching solutions. In view of the availability of the starting materials, production ease and etching solution penetration resistance, the number of carbons is preferably about 30 or smaller. In particular, a preferable alkyl (meth)acrylate has R² being a hexyl group, a heptyl group, an octyl group, a nonyl group, a 2-ethylhexyl group, or a propylhexyl group, etc. A more preferable alkyl (meth)acrylate has R² being a 2-ethylhexyl group. Among these monomers, can be used one species solely or a combination of two or more species.

In such a case, that is, when using a monomer with R² in the formula being an alkyl group with 6 or more (e.g. 7 or more, typically 8) carbons, the primary monomer may comprise a monomer other than the monomer with R² in the formula an alkyl group with 6 or more carbons, that is, an alkyl (meth)acrylate having an alkyl group with 1 to 5 carbons. Examples of such monomers include methyl (meth)acrylate, ethyl (meth)acrylate, propyl (meth)acrylate, isopropyl (meth)acrylate, butyl (meth)acrylate, isobutyl (meth)acrylate, s-butyl (meth)acrylate, t-butyl (meth)acrylate, pentyl (meth)acrylate, isopentyl (meth)acrylate, and the like. Among these, can be used one species solely or a combination of two or more species.

The ratio of the monomer with R² in the formula being an alkyl group having 6 or more carbons is preferably above 50% by mass. From the standpoint of increasing the hydrophobicity of the resulting PSA and increasing the etching solution penetration resistance, it is preferably 80% by mass or higher (e.g. 90% by mass or higher, typically 95% by mass or higher). It is more preferable to use, as the primary monomer, solely a monomer with R² in the formula being an alkyl group having 6 or more carbons. Thus, it is preferable that the ratio of an alkyl (meth)acrylate having an alkyl group with 1 to 5 carbons in the primary monomer is 10% by mass or lower (typically 5% by mass or lower), and it is more preferable that such an alkyl (meth)acrylate is not used.

To increase various features such as the non-contaminating property, light releasability, heat resistance, etc., the starting monomers used in polymerization to produce the acrylic polymer may comprise, in addition to the primary monomer, an optional monomer that is copolymerizable with the primary monomer as a comonomeric unit. The optional monomer encompasses not only monomers, but also oligomers.

The optional monomer can be a monomer having a functional group (or a functional group-containing monomer, hereinafter). Such a functional group-containing monomer can be added to incorporate crosslinking points into the acrylic polymer and increase the cohesive strength of the acrylic polymer. Examples of such a functional group-containing monomer include:

carboxyl group-containing monomers including ethylenic unsaturated mono-carboxylic acids such as acrylic acid, methacrylic acid, crotonic acid, carboxyethyl (meth)acrylate, carboxypentyl (meth)acrylate, etc.; ethylenic unsaturated dicarboxylic acids such as itaconic acid, maleic acid, fumaric acid, citraconic acid, etc.; and the like;

acid anhydride group-containing monomers such as acid anhydrides of the ethylenic unsaturated dicarboxylic acids, such as maleic anhydride, itaconic anhydride, etc.;

hydroxyl group-containing monomers including hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, (4-(hydroxymethylcyclohexyl)methyl (meth)acrylate, etc.; unsaturated alcohols such as N-methylol(meth)acrylamide, vinyl alcohol, allyl alcohol, 2-hydroxyethyl vinyl ether, 4-hydroxybutyl vinyl ether, diethylene glycol monovinyl ether, etc.; and the like;

functional group-containing monomers having nitrogen atoms in the functional groups, with examples including the following amide group-containing monomers, amino group-containing monomers and cyano group-containing monomers, etc., such as:

amide group-containing monomers such as (meth)acrylamide, N,N-dimethyl(meth)acrylamide, N-butyl(meth)acrylamide, N-methylol(meth)acrylamide, N-methylolpropane(meth)acrylamide, N-methoxymethyl(meth)acrylamide, N-butoxymethyl(meth)acrylamide, etc.;

amino group-containing monomers such as aminoethyl (meth)acrylate, N,N-dimethylaminoethyl (meth)acrylate, t-butylaminoethyl (meth)acrylate, etc.;

cyano group-containing monomers such as acrylonitrile, methacrylonitrile, etc.; sulfonate group-containing monomers such as styrene sulfonate, allyl sulfonate, 2-(meth)acrylamide-2-methylpropane sulfonate, (meth)acrylamidepropane sulfonate, sulfopropyl (meth)acrylate, (meth)acryloyloxynaphthalene sulfonate, etc.;

phosphate group-containing monomers such as 2-hydroxyethylacryloyl phosphate, etc.;

epoxy group (glycidyl group)-containing monomers such as glycidyl (meth)acrylate, methylglycidyl (meth)acrylate, allyl glycidyl ether, etc.;

keto group-containing monomers such as diacetone(meth)acrylamide, diacetone(meth)acrylate, vinyl methyl ketone, vinyl ethyl ketone, allyl acetoacetate, vinyl acetoacetate, etc.;

isocyanate group-containing monomers such as 2-(meth)acryloyloxyethyl isocyanate, etc.;

alkoxy group-containing monomers such as methoxyethyl (meth)acrylate, ethoxyethyl (meth)acrylate, etc.; and

alkoxysilyl group-containing monomers such as (3-(meth)acryloxypropyl)trimethoxysilane, (3-(meth)acryloxypropyl)triethoxysilane, (3-(meth)acryloxypropyl)methyldimethoxysilane, (3-(meth)acryloxypropyl)methyldiethoxysilane, etc. Among these, can be used one species solely or a combination of two or more species. In particular, for their abilities to preferably incorporate crosslinking points into an acrylic polymer and increase the cohesive strength of the acrylic polymer, functional group-containing monomers containing a carboxyl group, hydroxyl group, epoxy group, etc., are preferable, with carboxyl group-containing monomers and hydroxyl group-containing monomers being more preferable.

The optional monomer may comprise a monomer other than the functional group-containing monomer to increase the cohesive strength of the acrylic polymer, etc. Examples of such monomers include:

vinyl ester-based monomers such as vinyl acetate, vinyl propionate, etc.;

aromatic vinyl compounds such as styrene, substituted styrenes (α-methylstyrene, etc.), vinyl toluene, etc.;

aromatic ring-containing (meth)acrylates such as aryl (meth)acrylate (e.g. phenyl (meth)acrylate), aryloxyalkyl (meth)acrylate (e.g. phenoxyethyl (meth)acrylate), arylalkyl (meth)acrylate (e.g. benzyl (meth)acrylate), etc.;

monomers having nitrogen atom-containing rings such as N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-vinylmorpholine, N-vinylcaprolactam, N-(meth)acryloyl morpholine, etc.;

olefinic monomers such as ethylene, propylene, isoprene, butadiene, isobutylene, etc.;

chlorine-containing monomers such as vinyl chloride, vinylidene chloride, etc.;

vinyl ether-based monomers such as methyl vinyl ether, ethyl vinyl ether, etc.; and

cycloalkyl (meth)acrylates such as cyclopentyl (meth)acrylate, cyclohexyl (meth)acrylate, etc. Among these, can be used one species solely or a combination of two or more species. In particular, from the standpoint of increasing the cohesive strength of the resulting acrylic polymer, vinyl ester-based monomers are preferable. Among them, vinyl acetate is more preferable.

The optional monomer may comprise a comonomer such as polyfunctional monomers, etc., for crosslinking treatment, etc. Examples of such polyfunctional monomers include hexanediol di(meth)acrylate, (poly)ethylene glycol di(meth)acrylate, (poly)propylene glycol di(meth)acrylate, neopentyl glycol di(meth)acrylate, pentaerythritol di(meth)acrylate, trimethylolpropane tri(meth)acrylate, pentaerythritol tri(meth)acrylate, dipentaerythritol hexa(meth)acrylate, epoxy(meth)acrylate, polyester(meth)acrylate, and urethane(meth)acrylate. Among these, can be used one species solely or a combination of two or more species.

In terms of the content, the primary monomer should rank the highest among all the monomers (primary monomer and optional monomer) constituting the acrylic polymer main chain. From the standpoint of combining adhesive strength with light releasability and obtaining good etching solution penetration resistance, the primary monomer content is preferably higher than 50% by mass of all the monomers, or more preferably 60% by mass or higher (e.g. 70% by mass or higher, but 99% by mass or lower, typically 80% by mass or higher, but 98% by mass or lower). The ratio of the optional monomer is preferably lower than 50% by mass of all the monomers (e.g. 1% by mass to 40% by mass, 2% by mass to 20% by mass). In particular, when using a functional group-containing monomer described above as a monomer constituting the acrylic polymer main chain, from the standpoint of combining etching solution penetration resistance and light releasability while increasing the non-contaminating property and the light releasability, 1 part by mass to 10 parts by mass (e.g. 2 parts by mass to 8 parts by mass, typically 3 parts by mass to 7 parts by mass) of the functional group-containing monomer (preferably a carboxyl group-containing monomer) is preferably contained to 100 parts by mass of the primary monomer (an alkyl (meth)acrylate with R² in the formula being an alkyl group having preferably 6 or more carbons, or more preferably 8 carbons). When using a monomer other than the functional group-containing monomer as a monomer constituting the acrylic polymer main chain, from the standpoint of obtaining good etching solution penetration resistance, non-contaminating property and light releasability, 1 part by mass to 100 parts by mass (e.g. 2 parts by mass to 90 parts by mass, typically 5 parts by mass to 85 parts by mass) of the monomer (preferably a vinyl ester-based monomer such as vinyl acetate, etc.) other than the functional group-containing monomer is preferably contained to 100 parts by mass of the primary monomer (an alkyl (meth)acrylate with R² in the formula being an alkyl group having preferably 6 or more carbons, or more preferably 8 carbons). When using a polyfunctional monomer described above as a monomer constituting the acrylic polymer main chain, from the standpoint of obtaining good adhesive properties (e.g. adhesive strength) and etching solution penetration resistance, 30 parts by mass or less (e.g. 20 parts by mass or less, typically 1 part by mass to 10 parts by mass) of the polyfunctional monomer is contained to 100 parts by mass of the primary monomer.

The method for polymerizing the monomers or their mixture is not particularly limited, and a conventionally known general polymerization method can be employed. Examples of such polymerization methods include solution polymerization, emulsion polymerization, bulk polymerization, and suspension polymerization. Among these, for the excellent water resistance and etching solution penetration resistance obtained, solution polymerization is preferable. The embodiment of the polymerization is not particularly limited, and it can be carried out by suitably selecting a conventionally known monomer supply method, polymerization conditions (temperature, time, pressure, etc.), and other components (polymerization initiator, surfactant, etc.) besides the monomers. For example, as the monomer supply method, the entire monomer mixture can be supplied to a reaction vessel at once (all-at-once supply) or gradually supplied dropwise (continuous supply), or it can be divided into portions with each portion being supplied at a prescribed interval (portionwise supply). The monomers or their mixture may be supplied in part or in full as a solution dissolved in a solvent or as a dispersion emulsified in water.

The polymerization initiator is not particularly limited with examples including azo-based initiators, peroxide-based initiators, substituted ethane-based initiators, redox-based initiators combining peroxides and reductants, and so on. Examples of azo-based initiators include 2,2′-azobis(2-amidinopropane)dihydrochloride, 2,2′-azobis[N-(2-carboxyethyl)-2-methylpropionamidine]hydrate, 2,2′-azobisisobutyronitrile (AIBN), 2,2′-azobis-2-methylbutylonitrile (AMBN), 2,2′-azobis(2-methylpropionamidine)disulfate, 2,2′-azobis[2-(5-methyl-2-imidazolin-2-yl)propane]dihydrochloride and 2,2′-azobis(N,N′-dimethyleneisobutylamidine)dihydrochloride. Examples of peroxide-based initiators include persulfate salts such as potassium persulfate, ammonium persulfate, etc.; benzoyl peroxide (BPO), t-butyl hydroperoxide and hydrogen peroxide. Examples of substituted ethane-based initiators include phenyl-substituted ethanes. Examples of redox-based initiators include combinations of persulfate salts and sodium hydrogen sulfite, and combinations of peroxides and sodium ascorbate. Among these, from the standpoint of the etching solution penetration resistance, azo-based initiators are preferable.

The amount of polymerization initiator used can be suitably selected according to the type of polymerization initiator and the monomer species (composition of the monomer mixture), etc., while it is usually selected from a range of, for example, about 0.005 part by mass to 1 part by mass to 100 parts by mass of all the monomers. As a method for supplying the polymerization initiator, can be employed any of an all-at-once method where essentially all the polymerization initiator to be used is placed in a reaction vessel before starting the monomer mixture supply, a continuous supply method, a portionwise supply method, and so forth. From the standpoint of the polymerization procedural ease and process management ease, etc., for example, an all-at-once method can be preferably employed. The polymerization temperature can be, for instance, around 20° C. to 100° C. (typically 40° C. to 80° C.).

As the emulsifier (surfactant), anionic emulsifiers and non-ionic emulsifiers can be used preferably. Examples of anionic emulsifiers include alkylbenzene sulfonates such as sodium dodecylbenzene sulfonate, etc.; alkyl sulfates such as sodium lauryl sulfate, ammonium lauryl sulfate, etc.; sodium polyoxyethylene alkyl ether sulfates, ammonium polyoxyethylene alkyl phenyl ether sulfates, sodium polyoxyethylene alkyl phenyl ether sulfates, sodium polyoxyethylene alkyl sulfosuccinates, polyoxyethylene alkyl phosphoric acid esters, and the like. Examples of non-ionic surfactants include polyoxyethylene alkyl ethers, polyoxyethylene alkyl phenyl ethers, polyoxyethylene aliphatic acid esters, polyoxyethylene-polyoxypropylene block polymers, and the like. Alternatively, can be used a radically-polymerizing emulsifier (reactive emulsifier) having a structure of an anionic or non-ionic emulsifier with a radically-polymerizing group (vinyl group, propenyl group, isopropenyl group, vinyl ether group (vinyloxy group), allylether group (allyloxy group), etc.) introduced therein. Among these emulsifiers, solely one species or a combination of two or more species can be used. The amount of emulsifier used (based on the non-volatile content) can be, for instance, about 0.2 part by mass to 10 parts by mass (preferably about 0.5 part by mass to 5 parts by mass) relative to 100 parts by mass of all the monomers.

In the polymerization, as necessary, various conventionally known chain transfer agents (which may be considered as molecular weight-adjusting agents or polymerization degree-adjusting agents) can be used. Such chain transfer agents may be, for example, one, two or more species selected from mercaptans such as dodecylmercaptan (dodecanethiol), glycidylmercaptan, 2-mercaptoethanol, mercaptoacetic acid, 2-ethylhexyl thioglycolate, 2,3-dimercapto-1-propanol and the like. The amount of chain transfer agent used is not particularly limited while it can be selected from a range of, for example, about 0.001 part by mass to 0.5 part by mass relative to 100 parts by mass of all the monomers. With the amount of chain transfer agent used being within this range, it is unlikely to cause adhesive transfer on a surface of a glass substrate upon removal of the protective sheet, providing excellent non-contaminating property.

The PSA composition can further comprise a crosslinking agent in addition to the acrylic polymer as a base polymer. The type of crosslinking agent is not particularly limited, and a suitable one can be selected and used among various crosslinking agents usually used in the PSA field in accordance with, for example, the type of crosslinking functional group of the functional group-containing monomer, etc. Specific examples include isocyanate-based crosslinking agents such as polyisocyanates, etc., silane-based crosslinking agents, epoxy-based crosslinking agents, oxazoline-based crosslinking agents, aziridine-based crosslinking agents, metal chelate-based crosslinking agents, and melamine-based crosslinking agents. In particular, for their abilities to combine adhesiveness and light releasability at a high level, isocyanate-based crosslinking agents, epoxy-based crosslinking agents and melamine-based crosslinking agents are preferable. As for other advantages, isocyanate-based crosslinking agents and epoxy-based crosslinking agents can preferably form crosslinks with carboxyl group, and also due to their excellent storability, they can be handled easily and are highly acid-resistant as well. Although the amount of crosslinking agent contained in the PSA composition is not particularly limited, it can be about 0.5 part by mass to 10 parts by mass (e.g. 1 part by mass to 7 parts by mass, typically 2 parts by mass to 7 parts by mass) relative to 100 parts by mass of the acrylic polymer.

The PSA composition may further comprise a crosslinking accelerator. The type of crosslinking accelerator can be suitably selected according to the type of crosslinking agent used. The crosslinking accelerator in the present description refers to a catalyst that increases the rate of the crosslinking reaction by a crosslinking agent. Examples of such crosslinking accelerators include tin (Sn)-containing compounds such as dioctyltin dilaurate, dibutyltin dilaurate, dibutyltin diacetate, dibutyltin diacetylacetonate, tetra-n-butyltin and trimethyltin hydroxide; and nitrogen (N)-containing compounds, including amines such as N,N,N′,N′-tetramethylhexanediamine and triethylamine, and imidazoles. Among these, Sn-containing compounds are preferable. The use of these crosslinking accelerators are especially effective when the monomers constituting the acrylic polymer main chain comprise a hydroxyl group-containing monomer as a functional group-containing monomer while an isocyanate-based crosslinking agent is used as a crosslinking agent. The amount of crosslinking accelerator contained in the PSA composition can be, for instance, about 0.001 part by mass to 0.5 part by mass (preferably about 0.001 part by mass to 0.1 part by mass) relative to 100 parts by mass of the acrylic polymer.

The PSA composition may comprise a tackifier as necessary. Conventionally known tackifiers can be used without particular limitations. Examples include terpene-based tackifying resins, phenol-based tackifying resins, rosin-based tackifying resins, aliphatic petroleum resins, aromatic petroleum resins, copolymeric petroleum resins, alicyclic petroleum resins, xylene resins, epoxy-based tackifying resins, polyamide-based tackifying resins, ketone-based tackifying resins, and elastomer-based tackifying resins. Among these, can be used one species solely or a combination of two or more species. When using a tackifier, from the standpoint of obtaining sufficient effects by the tackifier without lowering the properties of the acrylic polymer, its amount used is preferably 50 parts by mass or less (typically 0.1 part by mass to 30 parts by mass) to 100 parts by mass of the acrylic polymer. In view of the adhesiveness, light releasability and non-contaminating property, the PSA composition may be in en embodiment essentially free of a tackifier.

The PSA composition may comprise, in addition to the acrylic polymer, one, two or more species of PSA selected from various known PSA such as rubber-based PSA (natural rubber-based, synthetic rubber-based, a mixture of these, etc.), silicone-based PSA, polyester-based PSA, urethane-based PSA, polyether-based PSA, polyamide-based PSA, fluorine-based PSA, etc. When using these PSA, from the standpoint of preventing the properties of the acrylic polymer from degrading, the amount used is, for example, about 10 parts by mass or less relative to 100 parts by mass of the acrylic polymer. In view of the etching solution penetration resistance, non-contaminating property and light releasability, it is preferably free of these PSA.

The PSA composition may comprise an acid or a base (aqueous ammonia, etc.) used for pH adjustment and so on. Optional components that may be contained in the composition include various additives generally used in the PSA field, such as antistatic agents, slip agents, anti-blocking agents, leveling agents, plasticizers, fillers, colorants (pigments, dyes, etc.), dispersants, stabilizing agents, preservatives, anti-aging agents, etc. The amounts of these additives added can be, as necessary, similar to the amounts usually added to PSA compositions for forming PSA layers (producing protective sheets) for the particular intended use.

The acrylic polymer content in the PSA composition is preferably higher than 50% by mass. In view of being likely to produce adhesiveness suitable for glass etching purpose and for simple molecular designing, it is more preferably 70% by mass or higher (e.g. 90% by mass or higher, typically 95% by mass or higher).

The state of the PSA composition is not particularly limited. It can be in various states such as solvent-based, emulsion-based, aqueous solution-based, active energy ray (UV)-curing type, hot-melt type, etc. Typically, it is prepared by adding other components as necessary to an acrylic polymer solution or dispersion obtained by polymerizing the monomers or their mixture in a suitable solvent. Alternatively, for example, it can be a solvent-based PSA composition obtainable by dissolving an acrylic polymer obtained via emulsion polymerization followed by procedures such as pH adjustment, salting-out, purification and so forth, along with a crosslinking agent and various additives (optional ingredients) as necessary in an organic solvent such as toluene, ethyl acetate, etc.

To combine sealing ability for an etching treatment and releasability after the treatment, can be used a PSA composition such that after the protective sheet is applied, the adhesive strength of the PSA is decreased afterwards by irradiation, heat, etc. Examples of such a PSA composition include intramolecularly irradiation/heat-curable PSA compositions in which carbon-carbon double bonds are included in acrylic polymer side chains or main chains, or at main chain terminals. With such an irradiation/heat-curable PSA composition, after a protective sheet comprising a PSA layer formed with the composition is adhered to an adherend, its adhesive strength can be decreased by curing by irradiation or heating. Other examples include an intermolecularly irradiation-curable PSA composition comprising a UV-curable monomer or oligomer. It is preferable that such a radiation-curable (typically UV-curable) PSA composition comprises a photopolymerization initiator. A preferable example can be a PSA composition comprising a component that foams up or expands by heat so that the PSA is allowed to expand at a prescribed temperature to decrease the adhesive strength. For example, such a PSA composition may comprise thermally-expandable microspheres (e.g. trade name “MICROSPHERE” available from Matsumoto Yushi-Seiyaku Co., Ltd., etc.) enclosing a substance that can be easily gasificated by heat, such as isobutene, propane, etc., in flexible shells. With use of an alkyl (meth)acrylate having an alkyl group with 12 or more carbons as a primary monomer constituting the acrylic polymer main chain, it is possible to employ a constitution such that the PSA is crystallized and the adhesive strength is reduced by heat.

As the method for providing a PSA layer to a substrate, for instance, can be employed a method (direct method) where the PSA composition is directly provided (typically applied) to a substrate and subjected to a curing treatment, or a method (transfer method) where the PSA composition is provided (typically applied) on top (of a surface (release face)) of a suitable separator (release paper) and subjected to a curing treatment to form a PSA layer on the separator's surface followed by adhering the PSA layer to a substrate to transfer the PSA layer to the substrate. The curing treatment may comprise one, two or more processes selected from drying (heating), cooling, crosslinking, supplemental copolymerization reaction, aging, etc. The curing treatment referred to herein also encompasses, for instance, a process (heating process, etc.) simply to allow a PSA composition containing a solvent to dry, a process simply to cool down (solidify) a heat-melted PSA composition. When the curing treatment comprises two or more processes (e.g. drying and crosslinking), these processes may be performed at once or stepwise.

The PSA composition can be applied, using a commonly-used coater such as a gravure roll coater, reverse roll coater, kiss roll coater, dip roll coater, bar coater, knife coater, spray coater, etc. From the standpoint of accelerating the crosslinking reaction and increasing the productivity, etc., the PSA composition is preferably dried with heating. Depending on the type of support to which the PSA composition is applied, for example, the drying temperature can be around 40° C. to 150° C. After dried, it may be subjected to an aging process of storing it around 40° C. to 60° C. so as to further accelerate the crosslinking reaction. The aging time may be suitably selected according to the desirable crosslinking degree and the rate at which the crosslinking reaction proceeds. It can be, for example, about 12 hours to 120 hours, typically 12 hours to 72 hours.

The thickness of the PSA layer is not particularly limited, and can be suitably modified according to the purpose. The PSA layer may have a thickness of, for instance, about 1 μm to 100 μm. For glass etching, the preferable thickness is 2 μm or larger, or more preferably 3 μm or larger (e.g. 5 μm or larger, typically 10 μm or larger) while it is 40 μm or smaller (typically 30 μm or smaller). When the PSA layer is too thick, the adhesive strength tends to be excessive while when it is too thin, the sealing ability tends to decrease.

The PSA layer provided on the substrate preferably has a storage elastic modulus G′ at 100° C. in a range of 0.230×10⁶ Pa to 10×10⁶ Pa. G′ is preferably in a range of 0.230×10⁶ Pa to 1.0×10⁶ Pa (e.g. 0.3×10⁶ Pa to 0.5×10⁶ Pa). The frequency used for the storage elastic modulus G′ measurement is 1 Hz. For instance, the storage elastic modulus can be measured at the frequency in the shear mode with a 2 mm thick PSA layer sample placed between parallel plates (7.9 mm diameter) of a general rheometer and a flat plate. The measurement temperature range and heating rate can be suitably selected according to the type of rheometer, etc. For example, the measurement can be taken over a temperature range (e.g. 15° C. to 150° C.) including at least a range of 50° C. to 130° C. while the heating rate can be about 0.5° C./min to 15° C./min (e.g. 5° C./min).

While the gel fraction of the PSA (layer) constituting the protective sheet is not particularly limited, it is preferably 60% or higher, more preferably 70% or higher, or even more preferably 75% or higher. With a high gel fraction of the PSA layer, sufficient cohesive strength can be obtained, making it unlikely to cause contamination such as adhesive transfer, etc., when the protective sheet is removed. It will be released more lightly as well. Furthermore, it is possible to obtain adhesive strength (i.e. adhesive strength combining sealing ability and light releasability at a high level) suitable for glass etching purpose; and therefore, while maintaining the favorable light releasability, it can prevent an etching solution from penetrating from a side of the protective sheet. The upper limit of the gel fraction is not particularly limited while it is preferably 99% or lower, or more preferably 90% or lower. Too high a gel fraction may lead to reduced adhesive strength depending on the constitution of the PSA layer.

The gel fraction can be determined by the following method: A PSA layer (crosslinked PSA (composition)) is wrapped into a pouch with a porous tetrafluoroethylene resin sheet (mass: Wa) of 0.2 μm average pore diameter and the total mass Wb of this pouch is measured. Subsequently the pouch is suspended in toluene and left still at room temperature for seven days. The pouch is then removed and allowed to dry at 120° C. for two hours and the mass Wc of the pouch after dried is measured. The gel fraction (%) of the PSA layer is determined from the next equation:

Gel fraction(%)=(Wc−Wa)/(Wb−Wa)×100

More specifically, a PSA layer (crosslinked PSA (composition)) as a measurement sample weighing approximately 0.1 g is wrapped into a pouch with a porous tetrafluoroethylene resin sheet of 0.2 μm average pore diameter, and the opening is tied with twine. The combined mass Wa (mg) of the porous tetrafluoroethylene resin sheet and the twine is measured in advance. The mass of the pouch (the combined mass of the PSA layer and the wrapping) Wb (mg) is measured. The pouch is placed in a screw vial of volume 50 mL (one screw vial used for each pouch), and the screw vial is filled with toluene. This is set still at room temperature (typically at 23° C.) for seven days, and the pouch is then removed and allowed to dry at 120° C. for two hours. The mass Wc (mg) of the pouch after dried is measured. The gel fraction of the measurement sample is determined by substituting the respective values into the equation. As the porous tetrafluoroethylene resin sheet, can be used trade name “NITOFLON (registered trademark) NTF1122” available from Nitto Denko Corporation. The same method can be used in the worked examples described later.

The adhering face of the PSA layer has an arithmetic mean surface roughness of preferably 1 μm or smaller, or more preferably in a range of about 0.05 μm to 0.75 μm (e.g. about 0.05 μm to 0.5 μm, typically about 0.1 μm to 0.3 μm). The arithmetic mean surface roughness of the adhering face can be measured in the same manner as the arithmetic mean surface roughness of the release face of a transfer sheet. In such a highly smooth PSA layer, stress is relatively evenly distributed when peeled away from an adherend surface, allowing avoidance of an event of the PSA being partially torn off by some local stress concentration and left on the adherend side, etc. Thus, a protective sheet comprising such a PSA layer on a substrate can be smoothly peeled away from an adherend without causing contamination such as adhesive transfer onto the adherend surface, etc. With increasing arithmetic mean surface roughness, the PSA layer may form a void due to floating, etc., at interfaces with the adherend and an etching solution may penetrate the protective sheet through the void. Of the substrate, the surface to which the PSA layer is placed preferably has such smoothness that it does not alter the surface condition (the surface roughness of the surface to be adhered) of the PSA layer (i.e. it does not cause to increase the arithmetic mean surface roughness of the release face).

The protective sheet may be present in a form such that a release liner is placed on the adhering face of the PSA layer. In general, a protective sheet is stamped out to a shape according to a protected area of an adherend and then adhered to the adherend. According to a protective sheet having a release liner on the PSA layer (protective sheet with release liner), the stamping-out procedure can be efficiently carried out. The protective sheet with release liner that has been stamped out is used by subsequently removing the release liner to expose the PSA layer and pressure-bonding the PSA layer (adhering face) to the adherend. When a release liner is placed on the adhering face while having a highly smooth surface (release face) to face the adhering face, the smooth PSA surface (adhering face) can be maintained more assuredly until the protective sheet is used. Accordingly, the PSA (layer) will have a highly smooth surface (adhering face) and stress will be relatively evenly distributed when peeled away from an adherend surface. It thus allows avoidance of an event of the PSA being partially torn off by some local stress concentration and partially left on the adherend side, etc. When it becomes less smooth (when the arithmetic mean surface roughness is increased), the PSA layer may form a void due to floating, etc. at interfaces with the adherend. In such a case, an etching solution may penetrate the protective sheet through the void. Thus, in the release liner, the arithmetic mean surface roughness of the surface (release face) that faces an adhering face is preferably 1 μm or smaller, or more preferably 0.05 μm to 0.75 μm (e.g. about 0.05 μm to 0.5 μm, typically about 0.1 μm to 0.3 μm).

As the release liner, can be preferably used various kinds of paper (the paper may have a surface laminated with resin) and resin film having the same constitution formed of the same material as the transfer sheet. The same sheet can be used as the transfer sheet and the release liner. For example, a PSA layer formed on a release face of a transfer sheet may be adhered to a substrate to transfer the PSA layer to the substrate, whereby the transfer sheet can be left as is on the PSA layer and used as the release liner. Such an embodiment where a transfer sheet doubles as a release liner is preferable from the standpoint of increasing the productivity, and reducing material costs and wastes. Alternatively, after a substrate is adhered to a PSA layer on a transfer sheet, the transfer sheet is removed from the PSA layer that has been transferred onto the substrate and a release liner different from the transfer sheet may be newly placed on the PSA layer (adhering face) to protect the PSA layer.

The thickness of the release liner is not particularly limited while it can be about 5 μm to 500 μm (e.g. about 10 μm to 200 μm, typically about 30 μm to 200 μm). The release face (the face placed in contact with the PSA layer) of the release liner may be subjected as necessary to a release treatment with a conventionally known release agent (e.g. general silicone-based, long chain alkyl-based, fluorine-based ones, etc.). The back face of the release face may be treated with a release agent, or may be subjected to a surface treatment other than a release treatment.

The protective sheet according to the second embodiment can be used as a protective sheet to be adhered to a desirable area of an adherend (typically a glass substrate) to protect the area. Such a protective sheet has suitable hardness. Thus, when adhering it to an adherend, it is unlikely to wrinkle, float or twist, making it easy to apply. Since the protective sheet is at or above a certain level of strength, it will not cause disadvantages such as tearing of the protective sheet upon removal. It can release lightly as well, providing excellent workability. Even if the adherend has an uneven surface, the protective sheet can well conform to the surface structure of the adherend, providing excellent adhesion. Accordingly, at sides of the protective sheet, there will be no formation of a void such as wrinkles or the like through which an etching solution could penetrate, thereby increasing the sealing ability. This protective sheet can be thus preferably used when an adherend surface is etched, for masking an area where effects by an etching solution should be avoided.

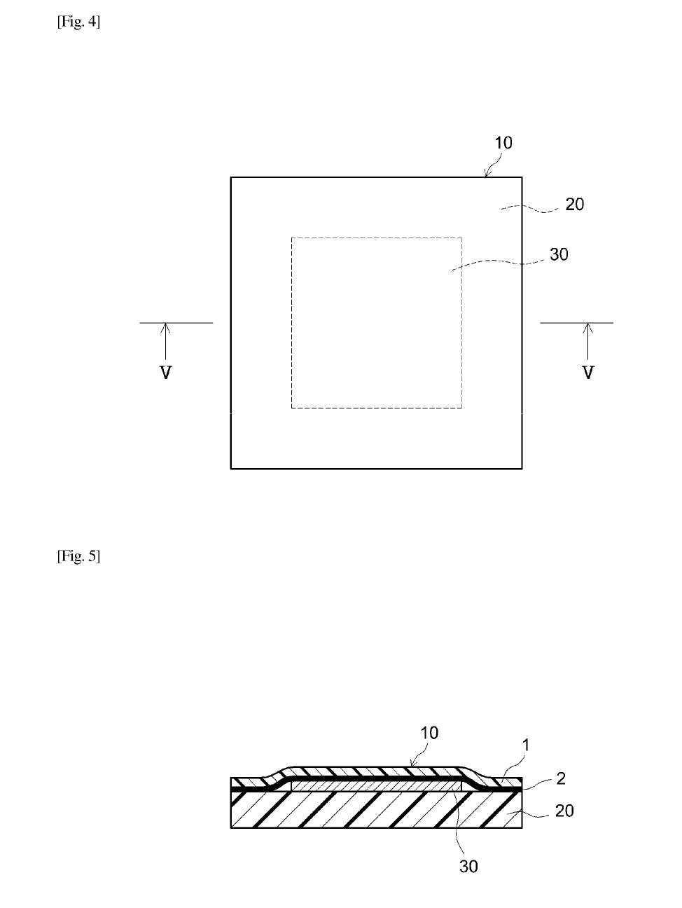

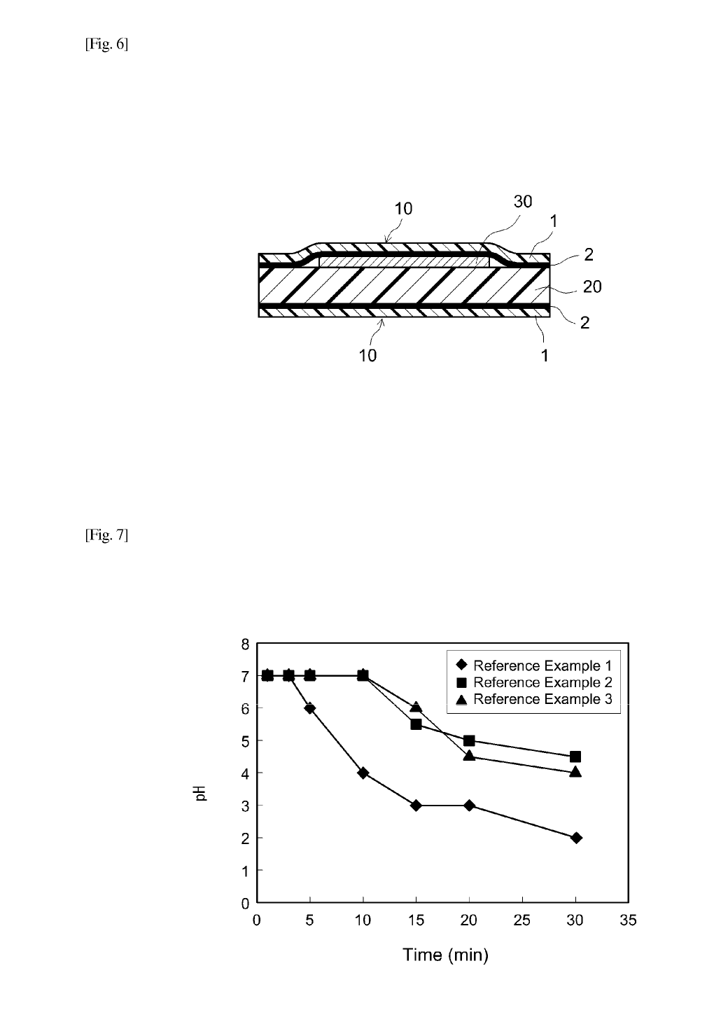

In particular, as shown in FIG. 4 and FIG. 5, the protective sheet according to the second embodiment is preferably used as a surface-protective sheet for a glass substrate 20, such that, when, before etching part of glass substrate 20 having ITO film 30 formed on its surface, a protective sheet 10 is adhered over its PSA layer side to the surface of glass substrate 20, it protects the surface (the surface on which ITO film 30 is formed) of glass substrate 20 from an etching solution. As shown in FIG. 6, it is preferably used as a protective sheet for both surfaces of glass substrate 20, such that, when, before etching a side being a cut-edge surface of glass substrate 20 having ITO film 30 formed on a surface, two sheets of protective sheet 10 are adhered over the respective PSA layer 2 sides to the both surfaces of glass substrate 20, they protect the both surfaces of glass substrate 20 from an etching solution. Such a constitution can be preferably used especially when etching a side of glass substrate 20. For applications shown in FIG. 4, FIG. 5 and FIG. 6, usually, ITO film of tens of nm thick (e.g. 10 nm to 90 nm thick) is formed (sometimes, a protective resin layer to protect the ITO film is further formed) on a glass substrate surface, yet the protective sheet described above can well conform to the uneven structure formed by the glass substrate and the ITO film, etc. The uneven structure is formed on an area around the center of the glass surface (in other words, the uneven structure does not extend to the edges on the glass substrate surface); and therefore, protective sheet 10 is adhered to completely cover the steps as shown in FIG. 4. In such usage, the protective sheet disclosed herein will not cause unfavorable effects to ITO film, such as the ITO film, etc., peeling off the glass substrate surface upon removal and so on, while it can combine sealing ability and workability at a high level.

Several experimental examples relating to the present invention are described below, although these specific examples are not intended to limit the scope of the invention. In the description that follows, unless noted otherwise, all references to “parts” and “%” are based on mass. Although not particularly limited, Experiment 1 includes worked examples related to the first embodiment of the present invention while Experiment 2 includes worked examples related to the second embodiment.

### Experiment 1

### Example 1

Using PE film as a substrate, a protective sheet was fabricated. A low-density polyethylene (trade name “PETROTHENE 180” available from Tosoh Corporation) was molded into 100 μm film at a die temperature of 160° C., using an inflation molding machine, and one face thereof was subjected to a corona discharge treatment to prepare a PE film. To the corona-treated face of the film, an acrylic PSA composition a was applied and allowed to dry at 80° C. for one minute to form a 3 μm thick PSA layer. To this PSA layer, a non-corona-treated face of the same film was adhered and the resultant was aged at 50° C. for two days to fabricate a protective sheet.

As the acrylic PSA composition a, was used a composition produced by the following method: To a reaction vessel equipped with a condenser, a nitrogen inlet, a thermometer and a stirrer, 100 parts of 2-ethylhexyl acrylate, 80 parts of vinyl acetate, 5 parts of acrylic acid and 0.3 part of benzoyl peroxide (BPO, “NYPER (registered trademark) BW” available from NOF Corporation) were added to a desirable non-volatile concentration in toluene, and let copolymerize to obtain an acrylic copolymer. To 100 parts of the acrylic polymer, was further added 2 parts of an epoxy-based crosslinking agent (“TETRAD (registered trademark)-C” available from Mitsubishi Gas Chemical Inc.). Toluene was added to a desirable non-volatile concentration to obtain an acrylic PSA composition a.

### Example 2

A protective sheet was fabricated in the same manner as Example 1 except that as the crosslinking agent, 4 parts of an epoxy-based crosslinking agent (“TETRAD (registered trademark)-C” available from Mitsubishi Gas Chemical Inc.) was added (in other words, the amount of the epoxy-based crosslinking agent used was doubled), and the thickness of the PSA layer was 10 μm.

### Example 3

The same substrate as Example 1 was molded as 150 μm thick film (in other words, a substrate was molded in the same manner as Example 1 except that the thickness of the substrate was 150 μm), and an acrylic composition b was applied to form a 10 μm thick PSA layer, whereby a protective sheet was fabricated. As the acrylic PSA composition b, was used a composition produced by the following method: To a reaction vessel equipped with a condenser, a nitrogen inlet, a thermometer and a stirrer, 100 parts of 2-ethylhexyl acrylate, 80 parts of vinyl acetate, 5 parts of acrylic acid and 0.3 part of benzoyl peroxide (BPO, “NYPER (registered trademark) BW” available from NOF Corporation) were added to a desirable non-volatile concentration in toluene, and let copolymerize to obtain an acrylic copolymer. To 100 parts of the acrylic polymer, were further added 20 parts of a xylene resin (“NIKANOL (registered trademark) H-80” available from Mitsubishi Gas Chemical Inc.), 2 parts of a butylated melamine-based crosslinking agent (“SUPER BECKAMINE (registered trademark) J-820-60N” available from DIC Corporation, 0.7 part of an alkyl phosphoric acid ester (“PHOSPHANOL (registered trademark) RL-210” available from TOHO Chemical Industry Co., Ltd.) and 5 parts of an isocyanate-based crosslinking agent (“CORONATE (registered trademark) L” available from Nippon Polyurethane Industry Co., Ltd.). Toluene was added to a desirable non-volatile concentration to obtain an acrylic PSA composition b.

### Example 4

A protective sheet was fabricated in the same manner as Example 1 except that the substrate was molded as 60 μm thick film (in other words, the substrate thickness was 60 μm).

### Comparative Example 1

The same substrate as Example 1 was molded as 55 μm thick film (in other words, a substrate was molded in the same manner as Example 1 except that the substrate thickness was 55 μm), and an acrylic composition c was applied to form a 5 μm thick PSA layer, whereby a protective sheet was fabricated. As the acrylic PSA composition c, was used a composition produced by the following method: In a reaction vessel equipped with a condenser, a nitrogen inlet, a thermometer and a stirrer, to 100 parts of a monomer mixture consisting of 58 parts of butyl acrylate, 40 parts of n-butyl methacrylate and 2 parts of acrylic acid, were added 1.65 parts of a surfactant (AQUALON (registered trademark) BC-2020 available from Dai-ichi Kogyo Seiyaku Co., Ltd.), 0.6 part of an alkyl phosphoric acid ester (“PHOSPHANOL RE-410” available from TOHO Chemical Industry Co., Ltd.) and 0.23 part of ammonium persulfate (“Ammonium Peroxodisulfate” available from Kishida Chemical Co., Ltd.) as a polymerization initiator to a desirable non-volatile concentration in water, and let emulsion-polymerize. With 10% aqueous ammonia, it was adjusted to pH 8 to obtain a polymer emulsion. The polymerization initiator was diluted with a prescribed amount of water and added dropwise. To 100 parts of non-volatiles of the polymer emulsion, 2 parts of an oxazoline-based crosslinking agent (“EPOCROS (registered trademark) WS-500” available from Nippon Shokubai Co., Ltd.) was mixed in to form an acrylic PSA composition c.

### Comparative Example 2

The same substrate as Example 1 was molded as 60 μm thick film (in other words, a substrate was molded in the same manner as Example 1 except that the substrate thickness was 60 μm), and an acrylic composition d was applied to form a 3 μm thick PSA layer, whereby a protective sheet was fabricated. As the acrylic PSA composition d, was used a composition produced by the following method: To a reaction vessel equipped with a condenser, a nitrogen inlet, a thermometer and a stirrer, 95 parts of 2-ethylhexyl acrylate, 5 parts of acrylic acid and 0.15 part of benzoyl peroxide (BPO, “NYPER (registered trademark) BW” available from NOF Corporation) were added to a desirable non-volatile concentration in toluene, and let copolymerize to obtain an acrylic copolymer. To 100 parts of the acrylic polymer, was further added 3 parts of an isocyanate-based crosslinking agent (“CORONATE (registered trademark) L” available from Nippon Polyurethane Industry Co., Ltd.). Toluene was added to a desirable non-volatile concentration to obtain an acrylic PSA composition d.

### Gel Fraction

Approximately 0.1 g (W1) of a PSA composition was wrapped with NITOFLON (registered trademark) and weighed. This was immersed in a solvent (toluene) and left at room temperature for one week. After the sample was dried, the mass (W2) of the insoluble portion was measured, and the gel fraction (%) was determined as 100×W2/W1

### Etching Solution Penetration

### (1) Etching Solution Penetration Through Protective Sheet Surface

A pH test strip was placed on a glass substrate and a protective sheet was adhered to completely cover the pH test strip. 2 mL of an etching solution was allowed to drop onto the protective sheet, and the presence of color change in the pH test strip was observed. When no color change occurred, it was rated “Resistant”. When some color change occurred, it was rated “Non-resistant”. As the etching solution, was used an aqueous solution (10-fold dilution of an original stock solution) containing a mixture of 1% HF, 2% H₂SO₄, 3% HNO₃ and 2% HPO₄.

pH test strip size: 9 mm×15 mm

Tape size: 40 mm×40 mm

### (2) Etching Solution Penetration Through Protective Sheet Sides

A protective sheet was adhered to a glass substrate and immersed in the etching solution for one hour. The protective sheet was observed from the protective sheet surface for the presence of erosion.

Etching solution penetration tests were carried out as (1) and (2) above, and when no etching solution penetration occurred through the protective sheet surface and no liquid penetration occurred through the protective sheet sides, it was rated A. When no liquid penetration occurred through the protective sheet sides, but partial etching solution penetration through the protective sheet surface was observed, it was rated B. When no etching solution penetration occurred through the protective sheet surface, but partial liquid penetration through the protective sheet sides was observed, it was rated C. When both etching solution penetration through the protective sheet surface and liquid penetration through the protective sheet sides were observed, it was rated F.

### Peeling Efficiency

A protective sheet was adhered to a glass substrate and immersed in the etching solution for one hour. Subsequently, the workability for removing the protective sheet was evaluated. When heavy release caused damage to the adherend, it was rated Poor while it did not affect the adherend, it was rated Good.

### Adhesive Strength to Glass

Measurement temperature: 25° C.

Test piece width: 20 mm

Tensile speed: 300 mm/min

Peel direction: 180°

Protective sheet size: 20 mm×60 mm (cut with the MD being in the length direction)

Glass: “MICROSLIDE GLASS” available from Matsunami Glass Ind., Ltd. 1.3 mm×65 mm×165 mm

Application method: Adhered with a 2 kg roller moved back and forth once.

Table 1 shows test results of Examples 1 to 4 and Comparative Examples 1 to 2.

TABLE 1

| | | | | | Comp. | Comp. |
|---|---|---|---|---|---|---|
| | Ex. 1 | Ex. 2 | Ex. 3 | Ex. 4 | Ex. 1 | Ex. 2 |
| Substrate | | | | | | |
| Material | PE | PE | PE | PE | PE | PE |
| Thickness (μm) | 100 | 100 | 150 | 60 | 55 | 60 |
| PSA | | | | | | |
| No. of carbons | 8 | 8 | 8 | 8 | 4 | 8 |
| in R² | | | | | | |
| Thickness (μm) | 3 | 10 | 10 | 3 | 5 | 3 |
| Gel fraction | ≧60 | ≧60 | ≧60 | ≧60 | 86 | 56.5 |
| (%) | | | | | | |
| Test results | | | | | | |
| Etching | A | A | A | B | F | C |
| solution | | | | | | |
| penetration | | | | | | |
| Peeling | Good | Good | Good | Good | Good | Poor |
| efficiency | | | | | | |
| Adhesive | 0.31 | 0.31 | 1.33 | 0.47 | 1.08 | — |
| strength | | | | | | |
| (N/20 mm) | | | | | | |

As evident from the results in Table 1, with respect to Examples 1 to 4 each having a gel fraction of 60% by mass or higher while using, as the primary monomer in the acrylic polymer, an alkyl (meth)acrylate with the alkyl group (R²) having 6 or more carbons, the ratings of etching solution penetration was either A or B, and they were found to provide excellent peeling efficiency for removing the protective sheet after etching. On the other hand, with respect to Comparative Examples 1 to 2 either having a gel fraction lower than 60% or using as the primary monomer of the acrylic polymer an alkyl (meth)acrylate with the alkyl group (R²) having 4 carbons, the ratings of etching solution penetration were either C or Poor as partial etching solution penetration through the protective sheet sides was observed. Based on these, it can be said that with a PSA layer having a gel fraction of 60% or higher and comprising an acrylic polymer formed with the primary monomer being an alkyl (meth)acrylate with the alkyl group (R²) having 6 or more carbons, excellent etching solution penetration resistance and peeling efficiency can be obtained.

### Reference Example 1

As the PSA composition, the acrylic PSA composition d was used

### Reference Example 2

An acrylic PSA composition e was prepared in the same manner as Reference Example 1 except that 0.6 part of an epoxy-based crosslinking agent (“TETRAD (registered trademark)-C” available from Mitsubishi Gas Chemical Inc.) was added as the crosslinking agent (in other words, except that, in place of 3 parts of the isocyanate-based crosslinking agent, 0.6 part of the epoxy-based crosslinking agent (“TETRAD (registered trademark)-C” available from Mitsubishi Gas Chemical Inc.) was used).

### Reference Example 3

An acrylic PSA composition f was prepared in the same manner as Reference Example 1 except that 1.2 parts of an epoxy-based crosslinking agent (“TETRAD (registered trademark)-C” available from Mitsubishi Gas Chemical Inc.) was added as the crosslinking agent (in other words, except that, in place of 3 parts of the isocyanate-based crosslinking agent, 1.2 part of the epoxy-based crosslinking agent (“TETRAD (registered trademark)-C” available from Mitsubishi Gas Chemical Inc.) was used).

With respect to the acrylic PSA compositions of Reference Examples 1 to 3 shown in Table 2, the following etching solution penetration test was performed. The results are shown in Table 3 and FIG. 7.

### Etching Solution Penetration Test for PSA Compositions

A pH test strip is placed on a glass substrate and a PSA composition was layered as 100 μm thick film so as to completely cover the pH test strip. 2 mL of an etching solution was allowed to drop onto the PSA composition, and the presence of color change in the pH test strip was observed. As the etching solution, was used an aqueous solution (10-fold dilution of an original stock solution) containing a mixture of 1% HF, 2% H₂SO₄, 3% HNO₃ and 2% HPO₄.

pH test strip size: 9 mm×15 mm

Tape (PSA layer) size: 40 mm×40 mm

TABLE 2

| | Ref. Ex. 1 | Ref. Ex. 2 | Ref. Ex. 3 |
|---|---|---|---|
| No. of carbons in R² | 8 | 8 | 8 |
| Crosslinking agent | | | |
| Type | Isocyanate-based | Epoxy-based | Epoxy-based |
| No. of parts | 3 | 0.6 | 1.2 |
| Gel fraction (%) | 56.5 | 89.1 | 93.3 |

TABLE 3

| Time | pH | | |
|---|---|---|---|
| (min) | Ref. Ex. 1 | Ref. Ex. 2 | Ref. Ex. 3 |
| 1 | 7 | 7 | 7 |
| 3 | 7 | 7 | 7 |
| 5 | 6 | 7 | 7 |
| 10 | 4 | 7 | 7 |
| 15 | 3 | 5.5 | 6 |
| 20 | 3 | 5 | 4.5 |
| 30 | 2 | 4.5 | 4 |

As shown in Table 3 and FIG. 7, when the etching solution penetration test was performed on the acrylic composition d (Ref. Ex. 1), e (Ref. Ex. 2) and f (Ref. Ex. 3), while color change was observed in the pH test strip over time in Reference Example 1 (gel fraction below 60%), color change in the pH test strip was slower in Reference Examples 2 and 3 (gel fractions at or above 60%) than in Reference Example 1. The gel fractions of Reference Examples 2 and 3 were measured by the same method as Example 1 described earlier, and both Reference Examples 2 and 3 had gel fractions of 60% or higher. Based on the above, it can be said that, with the gel fraction of an acrylic PSA composition (PSA, PSA layer) being 60% or higher, the etching solution penetration resistance will increase.

### Experiment 2

### Preparation of PSA Compositions

### Preparation Example 1

To a reaction vessel equipped with a condenser, a nitrogen inlet, a thermometer, an addition funnel and a stirrer, were placed 100 parts of toluene as a polymerization solvent, 100 parts of 2-ethylhexyl acrylate as a primary monomer, 5 parts of acrylic acid as a secondary monomer, 80 parts of vinyl acetate, and 0.3 part of benzoyl peroxide (BPO, “NYPER (registered trademark) BW” available from NOF Corporation) as a peroxide-based polymerization initiator. The reaction vessel was purged with nitrogen at room temperature for one hour. Subsequently, the reaction mixture was heated to a temperature of 63° C. and polymerization was carried out under a nitrogen flow for 4 hours. The reaction mixture was then heated to a temperature of 80° C. and aged for 2 hours to obtain a solution of an acrylic polymer A. The conversion of the acrylic polymer A was 99.5% by weight. To 100 parts (non-volatiles) of acrylic polymer A thus obtained, was added 2 parts (non-volatiles) of an epoxy-based crosslinking agent (“TETRAD (registered trademark)-C” available from Mitsubishi Gas Chemical Inc.) as a crosslinking agent to form a PSA composition A.

### Preparation Example 2

To a reaction vessel equipped with a condenser, a nitrogen inlet, a thermometer, an addition funnel and a stirrer, were placed 100 parts of ethyl acetate as a polymerization solvent, 95 parts of n-butyl methacrylate as a primary monomer, 5 parts of acrylic acid as a secondary monomer and 0.1 part of 2,2′-azobis-2-methylbutylonitrile (AMEN) as an azo-based polymerization initiator. The reaction vessel was purged with nitrogen at room temperature for one hour. Subsequently, the reaction mixture was heated to a temperature of 63° C. and polymerization was carried out under a nitrogen flow for 4 hours. The reaction mixture was then heated to a temperature of 80° C. and aged for 2 hours to obtain a solution of an acrylic polymer B. The conversion of the acrylic polymer B was 99.5% by weight. To 100 parts (non-volatiles) of acrylic polymer B thus obtained, was added 2 parts (non-volatiles) of an isocyanate-based crosslinking agent (adduct of trimethylolpropane and tolylene diisocyanate (“CORONATE (registered trademark) L” available from Nippon Polyurethane Industry Co., Ltd.) as a crosslinking agent to form a PSA composition B.

### Preparation Example 3

To a reaction vessel equipped with a condenser, a nitrogen inlet, a thermometer, an addition funnel and a stirrer, were placed 100 parts of ethyl acetate as a polymerization solvent, 95 parts of 2-ethylhexyl acrylate as a primary monomer, 5 parts of acrylic acid as a secondary monomer and 0.1 part of 2,2′-azobisbutylonitrile (AIBN) as an azo-based polymerization initiator. The reaction vessel was purged with nitrogen at room temperature for one hour. Subsequently, the reaction mixture was heated to a temperature of 60° C. and polymerization was carried out under a nitrogen flow for 4 hours. The reaction mixture was then heated to a temperature of 75° C. and aged for 2 hours to obtain a solution of an acrylic polymer C. The conversion of the acrylic polymer C was 99.9% by weight. To 100 parts (non-volatiles) of acrylic polymer C thus obtained, was added 3 parts (non-volatiles) of an isocyanate-based crosslinking agent (trade name “CORONATE (registered trademark) L”) as a crosslinking agent to form a PSA composition C.

### Preparation Example 4

To a reaction vessel equipped with a condenser, a nitrogen inlet, a thermometer, an addition funnel and a stirrer, were placed 65 parts of toluene as a polymerization solvent, 100 parts of 2-ethylhexyl acrylate as a primary monomer, 9.3 parts of 2-hydroxyethyl acrylate as a secondary monomer and 0.2 part of BPO as a peroxide-based polymerization initiator. Polymerization was carried out at 61° C. for 6 hours under a nitrogen flow to obtain an acrylic polymer D having a weight average molecular weight of about 58×10⁴. To the acrylic polymer D, was added 10.0 parts of 2-methacryloyloxyethyl isocyanate (MOI) (at 80 mol % relative to 2-hydroxyethyl acrylate). The addition reaction was carried out under an air flow at 50° C. for 48 hours to obtain a solution of an acrylic polymer. Subsequently, To 100 parts (non-volatiles) of the resulting acrylic polymer, were added 8 parts of an isocyanate-based crosslinking agent (trade name “CORONATE (registered trademark) L”) and 5 parts of a photopolymerization initiator (trade name “IRGACURE 250” available from BASF Corporation) to obtain a PSA composition D.

### Preparation Example 5

To a reaction vessel equipped with a condenser, a nitrogen inlet, a thermometer, an addition funnel and a stirrer, were placed 100 parts of ethyl acetate as a polymerization solvent, 50 parts of 2-ethylhexyl acrylate and 50 parts of ethyl acrylate as primary monomers, 5 parts of 2-hydroxyethyl acrylate as a secondary monomer and 0.1 part of AMEN as an azo-based polymerization initiator. The reaction vessel was purged with nitrogen at room temperature for one hour. Subsequently, the reaction mixture was heated to a temperature of 63° C. and polymerization was carried out under a nitrogen flow for 4 hours. The reaction mixture was then heated to a temperature of 80° C. and aged for 2 hours to obtain a solution of an acrylic polymer E. The conversion of the acrylic polymer E was 99.5% by weight. To 100 parts (non-volatiles) of acrylic polymer E thus obtained, were added 2 parts of an isocyanate-based crosslinking agent (trade name “CORONATE (registered trademark) L”), 10 parts of an alkylphenol resin (“TAMANOL 100S” available from Arakawa Chemical Industries, Ltd.) and 40 parts of thermally-expandable microspheres (“MATSUMOTO MICROSPHERE F50D” available from Matsumoto Yushi-Seiyaku Co., Ltd.; temperature at which foaming starts: 120° C., average particle diameter: 14 μm) to obtain a PSA composition E.

### Preparation Example 6

To a reaction vessel equipped with a condenser, a nitrogen inlet, a thermometer, an addition funnel and a stirrer, were placed 100 parts of toluene as a polymerization solvent, 100 parts of 2-ethylhexyl acrylate as a primary monomer, 5 parts of acrylic acid as a secondary monomer, 80 parts of vinyl acetate, and 0.3 part of benzoyl peroxide (BPO, “NYPER (registered trademark) BW” available from NOF Corporation) as a peroxide-based polymerization initiator. The reaction vessel was purged with nitrogen at room temperature for one hour. Subsequently, the reaction mixture was heated to a temperature of 63° C. and polymerization was carried out under a nitrogen flow for 4 hours. The reaction mixture was then heated to a temperature of 80° C. and aged for 2 hours to obtain a solution of an acrylic polymer F. The conversion of the acrylic polymer F was 99.5% by weight. To 100 parts (non-volatiles) of acrylic polymer F thus obtained, was added 1.5 parts (non-volatiles) of an epoxy-based crosslinking agent (“TETRAD (registered trademark)-C” available from Mitsubishi Gas Chemical Inc.) as a crosslinking agent to form a PSA composition F.

### Fabrication of Substrates

### Fabrication Example 1

Using a T-die extruder, a low-density polyethylene (“PETROTHENE (registered trademark) 186R” available from Tosoh Corporation) was molded to obtain a 150 μm thick substrate film A. One face of the substrate A was subjected to a corona discharge treatment.

### Fabrication Example 2

30 parts of an ethylene-vinyl acetate copolymer (EVA) (“ULTRATHENE (registered trademark) 635” available from Tosoh Corporation), 70 parts of a multiple-stepwise-polymerized ethylene/propylene copolymer (“CATALLOY Q-200F” available from SunAllomer, Ltd.), 35 parts of an aminosilane coupling agent-coated calcined kaolin (“TRANSLINK 445” available from BASF Corporation) and 0.5 part of a phenol-based antioxidant (“ADK STAB (registered trademark) AO-60” available from ADEKA Corporation) were dry-blended and kneaded at 180° C. with a pressure kneader to form pellets. Using a calender extruder, the pellets were molded to obtain a 150 μm thick substrate film B. One face of the substrate B was subjected to a corona discharge treatment.

### Fabrication Example 3

Using a T-die extruder, an ethylene-vinyl acetate copolymer (EVA) (“EVAFLEX (registered trademark) EV270” available from DuPont-Mitsui Polychemicals Co., Ltd.) was molded to obtain a 115 μm thick substrate film C. One face of the substrate C was subjected to a corona discharge treatment.

### Fabrication Example 4

A 75 μm thick polyethylene terephthalate (“LUMIRROR (registered trademark) S-10” available from Toray Industries, Inc.) was used as a substrate D.

### Fabrication Example 5

Except that the film thickness was modified to 100 μm, a substrate E was fabricated in the same manner as Fabrication Example 1. One face of the substrate E was subjected to a corona discharge treatment.

### Example 1 to Example 10

The resulting PSA compositions A to F were each applied with an applicator to one face of a 38 μm thick silicone-treated polyethylene terephthalate (PET) film, and allowed to dry at a temperature of 120° C. for 3 minutes to form a PSA layer having the thickness shown in Table 4. So as to pair PSA species formed from the PSA compositions A to F with the substrates A to E as shown in Table 4, to the surfaces opposite of the PET film sides of the PSA layers, the corona-discharge-treated faces of the substrates were adhered to fabricate protective sheets according to Example 1 to Example 10. The protective sheets fabricated in the respective examples were subjected to the following evaluation tests.

### Strength at 10% Stretch

For each protective sheet, the strength at 10% stretch was measured by the following method: In particular, with the release liner being placed on the PSA layer (as the protective sheet with release liner), the protective sheet was cut along the MD of the substrate to obtain a strip of 10 mm wide by 150 mm long, the release liner was removed, and the resultant was used as a test piece. Based on JIS K7127, the strength T_{M25} (N/cm) of the test piece when stretched by 10% in the MD was measured under the following conditions.

### Measurement Conditions for the Strength at 10% Stretch:

Measurement temperature 25° C. (test piece was stored at this temperature for 30 minutes or longer before measurement was started);

Tensile speed 300 mm/min;

Chuck interval 100 mm;

With respect to each protective sheet, using a test piece cut as a 10 mm wide strip with the TD being in the length direction, in the same manner as the above, the strength (tensile strength) when stretched by 10% in the TD was measured to determine the strength T_{T25} (N/cm) at 10% stretch in TD.

From T_{M25} and T_{T25} measured, their total value T_{S25} was determined.

### 25° C. Tensile Modulus

Each protective sheet was cut to a 10 mm wide strip with the MD being in the length direction to prepare a test piece. Based on JIS K7161, the test piece was elongated under the following conditions to obtain a stress-strain curve.

### Elongation Conditions:

Measurement temperature 25° C.;

Tensile speed 300 mm/min;

Chuck interval 50 mm;

The MD tensile modulus E_{M25} was determined by linear regression of a curve between two specific strain points, ε1=1 and ε2=2. The measurement was performed on three test pieces cut out from different locations, and their average value was recorded as the tensile modulus E_{M25} (MPa) in MD at 25° C. Each protective sheet was cut to a 10 mm wide strip with the TD being in the length direction to prepare a test piece. Using this test strip, in the same manner as the above, the tensile modulus E_{T25} (MPa) in TD at 25° C. was determined. From E_{M25} and E_{T25} measured, their total value E_{S25} (MPa) was determined. E_{M25} and E_{T25} were determined by converting the values to values per cross-sectional surface area of the substrate based on the thickness value obtained by subtracting the PSA layer thickness from the actual thickness of each protective sheet or the value obtained by actually measuring the thickness of the substrate itself.

### Flexural Rigidity Value at 25° C.

From E_{M25} and E_{T25} measured, thickness h of each substrate, and an equation:

D=Eh³/12(1−V²)

flexural strength values D_{M25} and D_{T25} (Pa·m³) were determined, respectively, and their total value D_{S25} was computed. Herein, for the value of Poisson's ratio Vin the equation, 0.35 was used.

### Deflection Angle Test

As shown in FIG. 3, a protective sheet 10 of each example cut to 100 mm by 50 mm was obtained, and the protective sheet 10 was fixed on a test board 40 such that, from a side view, a section of protective sheet 10 measuring 60 mm in the length direction was on the test board 40 having a level surface while the remaining 40 mm section in the length direction extended laterally from an edge of test board 40. The angle A° formed by the extending section of protective sheet 10 relative to the vertical direction was measured. The angle A° was recorded as the deflection angle.

### Sealing Ability Test

70 mm by 70 mm polyester PSA tape (“No. 31B” available from Nitto Denko Corporation) of 53 μm overall thickness was adhered to the center of a 100 mm by 100 mm glass plate to create a step on the glass surface. The protective sheets fabricated in Example 1 to Example 10 were cut to 100 mm by 100 mm and adhered with a hand roller to completely cover the polyester PSA tape and overlay the glass plate, and the resultant was used as a test sample. Each test sample was left in water for 24 hours and subsequently removed. The protective sheet was peeled away from the glass plate and the area to which the protective sheet had been adhered was visually inspected for the degree of water penetration. When no water penetration into the protective sheet was observed, it was rated S (superb). When minute water penetration into the protective sheet was observed, it was rated G (good). When definite water penetration was observed, it was rated P (poor). With respect to the sealing ability and the releasability described next, the protective sheet of Example 5 using a UV-curable PSA was tested after the PSA layer was irradiated with UV (cumulative radiation dose: 50 mJ/cm² to 500 mJ/cm²). The protective sheet of Example 6 with the PSA comprising thermally-expandable microspheres was tested after the PSA layer was heated at 120° C. for 5 minutes.

### Releasability Test

In the sealing ability test, the workability for removing the protective sheet from the glass plate was evaluated. When the release was smooth with no elongation or tearing of the protective sheet and no peeling of the polyester PSA tape, it was rated Good. When the release was heavy and some elongation was observed in the protective sheet, it was rated Poor.

TABLE 4

| | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|
| Substrate | | | | | | | | | | |
| Type | A | B | A | A | A | B | E | A | D | C |
| Thickness (μm) | 150 | 150 | 150 | 150 | 150 | 150 | 100 | 150 | 75 | 115 |
| PSA | | | | | | | | | | |
| PSA composition | B | B | A | C | D | E | A | F | B | B |
| Thickness (μm) | 20 | 10 | 20 | 20 | 20 | 20 | 15 | 30 | 20 | 20 |
| Tensile modulus (MPa) | | | | | | | | | | |
| E_{M25} | 280.6 | 154.3 | 280.6 | 280.6 | 280.6 | 154.3 | 326.0 | 280.6 | 3702.7 | 39.0 |
| E_{T25} | 383.4 | 100.0 | 383.4 | 383.4 | 383.4 | 100.0 | 260.3 | 383.4 | 3706.9 | 39.0 |
| E_{S25} | 664.0 | 254.3 | 664.0 | 664.0 | 664.0 | 254.3 | 586.3 | 664.0 | 7409.6 | 78.0 |
| Flexural strength | | | | | | | | | | |
| (10⁻⁵ × Pa/m³) | | | | | | | | | | |
| D_{M25} | 9.0 | 4.9 | 9.0 | 9.0 | 9.0 | 4.9 | 3.1 | 9.0 | 15.0 | 0.6 |
| D_{T25} | 12.0 | 3.2 | 12.0 | 12.0 | 12.0 | 3.2 | 2.5 | 12.0 | 15.0 | 0.6 |
| D_{S25} | 21.0 | 8.1 | 21.0 | 21.0 | 21.0 | 8.1 | 5.6 | 21.0 | 30.0 | 1.1 |
| Strength @ 10% stretch | | | | | | | | | | |
| (N/cm) | | | | | | | | | | |
| T_{M25} | 17.0 | 10.4 | 17.0 | 17.0 | 17.0 | 10.4 | 12.6 | 17.0 | 89.1 | 6.0 |
| T_{T25} | 18.2 | 7.3 | 18.2 | 18.2 | 18.2 | 7.3 | 11.5 | 18.2 | 85.5 | 5.9 |
| T_{S25} | 35.2 | 17.7 | 35.2 | 35.2 | 35.2 | 17.7 | 24.1 | 35.2 | 174.6 | 11.9 |
| Deflection angle (°) | 77 | 67 | 77 | 77 | 77 | 67 | 72 | 77 | 84 | 50 |
| Sealing ability | G | S | G | G | G | S | G | S | P | S |
| Releasability | G | G | G | G | G | G | G | G | G | P |

As shown in Table 4, with respect to the protective sheets of Example 1 to Example 8 and Example 10 with the strength (T_{M25}, T_{M25}) in each direction (MD or TD) at 10% stretch being in a range of 1 N/cm to 25 N/cm, the sealing ability was found excellent. On the other hand, with respect to the protective sheet of Example 9 with each strength (T_{M25}, T_{M25}) being above 25 N/cm, good sealing ability was not obtained. One cause could be that with the excessively high strength at 10% stretch, it did not sufficiently conform to the surface structure of the glass.

With respect to the protective sheet of Example 1 to Example 8 with the MD flexural strength value D_{M25} being in a range of 1.5×10⁻⁵ Pa·m³ to 10×10⁻⁵ Pa·m³, both the sealing ability and the releasability were found excellent. On the other hand, with respect to the protective sheet of Example 9 with the flexural strength values D_{M25} and D_{T25} being greater than 10×10⁻⁵ Pa·m³, good sealing ability was not obtained. With respect to the protective sheet of Example 10 with the flexural strength values D_{M25} and D_{T25} being less than 1.5×10⁻⁵ Pa·m³, the releasability was inferior. With respect to the protective sheet of Example 5 using a UV-curable PSA, UV irradiation reduced the adhesive strength to glass of the PSA layer, allowing easy removal. As a result, light release was realized without damaging the glass. With respect to the protective sheet of Example 6 with the PSA comprising thermally-expandable microspheres, since the heating the PSA layer caused thermal expansion, the adhesive strength of the PSA layer to glass decreased, allowing easy removal. As a result, light release was realized without damaging the glass.

With respect to the protective sheets of Example 1 to Example 8 which were found to have both good sealing abilities and good releasabilities, all had deflection angles within a range of 60° to 80°. From these results, it can be presumed that a protective sheet having a deflection angle within this range tends to be likely to combine sealing ability and releasability.

While specific examples of the present invention are described above, these are merely illustrative examples and are not to limit the scope of claims. The art described in the claims includes various changes and modifications made to the specific examples described above.

### REFERENCE SIGNS LIST

1: substrate
2: PSA layer
3: release liner
10: protective sheet
20: glass substrate
30: ITO film
40: test board

1. A protective sheet for glass etching, the protective sheet protecting a non-etching area from an etching solution by being adhered to the non-etching area when etching glass, the protective sheet comprising:
a substrate; and
a pressure-sensitive adhesive layer provided on one face of the substrate, wherein
the pressure-sensitive adhesive layer is constituted with a pressure-sensitive adhesive having a gel fraction of 60% or higher,
the pressure-sensitive adhesive is an acrylic pressure-sensitive adhesive comprising an acrylic polymer as a primary component, and
the acrylic polymer is synthesized by polymerizing starting monomers comprising, as a primary monomer, a monomer represented by a formula:
CH₂═CR¹COOR²
(in the formula, R¹ is a hydrogen atom or a methyl group, and R² is an alkyl group), the primary monomer comprising, as a primary component, a monomer with R² in the formula being an alkyl group having 6 or more carbons.

2. The protective sheet for glass etching according to claim 1, the protective sheet protecting a non-etching area from an etching solution by being adhered to the non-etching area when etching glass, the protective sheet comprising:
a substrate; and
a pressure-sensitive adhesive layer provided on one face of the substrate, wherein
the pressure-sensitive adhesive layer has a gel fraction of 60% or higher, and
the pressure-sensitive adhesive layer is an acrylic polymer formed with a primary monomer being a monomer represented by a formula (1):
CH₂═CR¹COOR² (1)
(in the formula, R¹ is a hydrogen atom or a methyl group, and R² is an alkyl group having 6 or more carbons).

3. The protective sheet for glass etching according to claim 1, wherein the pressure-sensitive adhesive layer comprises a monomer having a carboxyl group or a hydroxyl group.

4. The protective sheet for glass etching according to claim 1, wherein the substrate has a thickness of 80 μm or larger.

5. The protective sheet for glass etching according to claim 1, wherein the substrate has a front face on the pressure-sensitive adhesive layer side and a back face, of which one or each has an arithmetic mean surface roughness of 0.05 μm to 1 μm.

6. The protective sheet for glass etching according to claim 1, having an adhesive strength to glass of 0.05 N/20 mm to 3.00 N/20 mm.

7. The protective sheet for glass etching according to claim 1, wherein the substrate comprises a layer formed from polypropylene, polyethylene, polyethylene terephthalate, polyvinyl chloride, polyimide, polybutylene terephthalate, polyphenylene sulfide, ethylene vinyl acetate or polytetrafluoroethylene.

8. The protective sheet for glass etching according to claim 1, wherein the pressure-sensitive adhesive comprises a crosslinking agent, and the crosslinking agent is an epoxy-based crosslinking agent or an isocyanate-based crosslinking agent.

9. The protective sheet for glass etching according to claim 1, used as a surface protective sheet for a glass substrate, the surface protective sheet protecting a non-etching area of one surface of the glass substrate from an etching solution by being adhered over its pressure-sensitive adhesive layer side to the non-etching area before etching surfaces of the glass substrate.

10. A protective sheet for glass etching, comprising:
a substrate; and
a pressure-sensitive adhesive layer provided on one face of the substrate, wherein
the protective sheet has a strength T_{M25} at 10% stretch in its MD (machine direction) at a temperature of 25° C. and a strength T_{T25} at 10% stretch in its TD (transverse direction) perpendicular to the MD at the same temperature, and
at least one value of the strength T_{M25} and the strength T_{T25} is 1 N/cm to 25 N/cm.

11. The protective sheet for glass etching according to claim 10, wherein the protective sheet has a flexural rigidity D_{M25} in the MD at a temperature of 25° C. and a flexural rigidity D_{T25} in the TD at the same temperature, and
at least one value of the flexural rigidity D_{M25} and the flexural rigidity D_{T25} is 1.5×10⁻⁵ Pa·m³ to 10×10⁻⁵ Pa·m³.

12. The protective sheet for glass etching according to claim 10, wherein the protective sheet further comprises a release liner placed on a surface opposite of the substrate side of the pressure-sensitive adhesive layer, and the release liner has an arithmetic mean surface roughness of 0.05 μm to 0.75 μm.

13. The protective sheet for glass etching according to claim 10, used as a protective sheet for both surfaces of a glass substrate, the protective sheet protecting the both surfaces of the glass substrate from an etching solution by a constitution that at least two sheets of the protective sheet are adhered over their respective pressure-sensitive adhesive layer sides to the both surfaces of the glass substrate, respectively, before etching a side being a cut-edge surface of the glass substrate.

14. The protective sheet for glass etching according to claim 2, wherein the pressure-sensitive adhesive layer comprises a monomer having a carboxyl group or a hydroxyl group.

15. The protective sheet for glass etching according to claim 2, wherein the substrate has a thickness of 80 μm or larger.

16. The protective sheet for glass etching according to claim 2, wherein the substrate has a front face on the pressure-sensitive adhesive layer side and a back face, of which one or each has an arithmetic mean surface roughness of 0.05 μm to 1 μm.

17. The protective sheet for glass etching according to claim 2, having an adhesive strength to glass of 0.05 N/20 mm to 3.00 N/20 mm.

18. The protective sheet for glass etching according to claim 2, wherein the substrate comprises a layer formed from polypropylene, polyethylene, polyethylene terephthalate, polyvinyl chloride, polyimide, polybutylene terephthalate, polyphenylene sulfide, ethylene vinyl acetate or polytetrafluoroethylene.

19. The protective sheet for glass etching according to claim 2, wherein the pressure-sensitive adhesive comprises a crosslinking agent, and the crosslinking agent is an epoxy-based crosslinking agent or an isocyanate-based crosslinking agent.

20. The protective sheet for glass etching according to claim 2, used as a surface protective sheet for a glass substrate, the surface protective sheet protecting a non-etching area of one surface of the glass substrate from an etching solution by being adhered over its pressure-sensitive adhesive layer side to the non-etching area before etching surfaces of the glass substrate.
